(19) United States
(12) Patent Application Publication
(10) Pub. No.: US 2011/0108012 A1
(43) Pub. Date: May 12, 2011

(54) INTERNAL COMBUSTION ENGINE AND WORKING CYCLE

(76) Inventors: Clyde C. Bryant, Alpharetta, GA (US); Mark Bryant, Alpharetta, GA (US)

(21) Appl. No.: 12/952,270

(22) Filed: Nov. 23, 2010

Related U.S. Application Data
(63) Continuation of application No. PCT/US09/45909, filed on Jun. 2, 2009.
(60) Provisional application No. 61/058,290, filed on Jun. 3, 2008.

(51) Int. Cl. F02M 25/07

(52) U.S. Cl. 123/568.11

(57) ABSTRACT

An internal combustion engine (ICE) system (including methods and apparatuses) for managing combustion charge densities, temperatures, pressures and turbulence in order to produce a true mastery within the combustion chamber in order to increase fuel economy, power, torque and engine life while minimizing polluting emissions and noxious odors.

### CROSS-REFERENCE TO RELATED APPLICATIONS

This application is a continuation of International Application No. PCT/US09/045,909, filed Jun. 2, 2009; which application claims the benefit of U.S. provisional patent application No. 61/058,290, with a filing date of Jun. 3, 2008. The specification and drawings of International Application No. PCT/US09/045,909 and U.S. provisional patent application No. 61/058,290 are specifically hereby incorporated herein in their entirety by reference.

### SUMMARY OF THE INVENTION

This invention relates to methods and apparatuses for deriving mechanical work from combusting fuel in an internal combustion engine (ICE).

Briefly described, the present invention comprises an internal combustion engine (ICE) system (including methods and apparatuses) for managing combustion charge densities, temperatures, pressures and turbulence in order to produce a true mastery within the combustion chamber in order to increase fuel economy, power, torque and engine life while minimizing polluting emissions and noxious odors.

According to exemplary embodiments, a method includes the steps of: (i) producing an air or air-recirculated-exhaust-gas (REG) charge, (ii) adjusting the temperature, density and pressure of the fuel and/or air charge such that a charge having a varying weight and density selected from a range of weight and density levels ranging from atmospheric weight and density to a heavier-than-atmospheric weight and density, (iii) transferring the charge to a cylinder or compression chamber of the engine with great turbulence, (iv) in all combustion systems, at the beginning of the compression stroke or process, adjusting the combustion charge volume by recessing a selective portion of the charge, which charge has absorbed heat from the engine inner components, and which portion of the charge is now expelled, going through an outlet valve and an intercooler and returning by conduit to an intake manifold, the outlet valve now closing, in combustion system (a) selectively trapping a volume of charge at any level between 80% and zero % of displaceable volume of the cylinder, or compression chamber, plus the volume of the combustion chamber, [or alternatively after recessing the engine cooling portion of charge, (iva), adjusting the charge volume by trapping, non-selectively, a volume of charge at any level of between 80% and zero percent of the displaceable volume of the cylinder or compression chamber, plus the volume of the combustion chamber], which system is designated as combustion system (b), whereby in this combustion system, the mean effective cylinder pressure is selectively variable and is varied by varying fuel input and/or charge density and pressure. Now in step (v), in combustion system (a) and (b), additional compression takes place on any charge trapped by outlet valve closure outside the combustion chamber and (vi) causing a predetermined quantity of charge-air and fuel, or charge-air-fuel-REG mix to produce a combustible mixture, and (vii) causing the mixture to be ignited within the combustion chamber, [or alternatively and preferably (viia), causing the charge to be ignited with piston at between 20 and 5 degrees of crank angle before top dead center (BTDC) of piston, or “seating” of the combustion chamber and (viii) allowing the combusting gas to expand against and to the length of travel by a piston or rotor lobe operable in the power cylinder or compression chamber with the expansion ratio being substantially greater than the effective compression ratio of the power cylinder or compression chamber of the engine, (ix) opening an exhaust valve or port at or near the end of the power stroke or expansion process, (x) allowing the exhausted gases, assisted by piston or rotor lobe stroke to travel by a conduit to and through an optional filter, with optional valve V1 alternatively adjusting the volume of exhaust gases driving turbine of turbocharger, thus controlling the speed of turbine compressor, thus controlling the boost pressure of the turbine(s) of which there is alternatively as many in number as one to four in-series which provide pressurized air to the engines of this invention.

In an alternate arrangement, section (iib), also adjusting the temperature, density and pressure of the fuel, especially (but not limited to) if the fuel is liquefied gaseous, or is gaseous at room temperatures such as hydrogen and natural gas (which fuels are sometimes present as liquefied or compressed gas).

In addition to other advantages, in section (ii), the invented method increases the density of the air charge [and/or alternatively, in Section (iia), increases or retains the density of gaseous fuel.] The invented method also extends the ignited charge expansion process and is capable of producing mean effective pressures (mep) which are higher than produced by traditional reciprocating or rotary engines for all fuels whether liquid, liquefied gaseous, or gaseous.

In the preferred embodiments, combustion system (a) the effective compression ratio is selectively variable (and is selectively varied) throughout the mentioned range during the operation of the engine.

In the embodiments of engine of engine of FIG. 1, the apparatus of the present invention provides a reciprocating ICE with at least one air intake port, at least one ancillary compressor for compressing an air charge, at least one intercooler through which the compressed air can be directed for cooling, a combustion chamber in which the combustion gas is ignited and expanded, a piston operable in a power cylinder and connected to a crankshaft by a connecting link for rotating the crankshaft in response to reciprocation of each piston, a transfer conduit communicating the compressor outlet to an optional control valve and to a pre-cooler and/or an intercooler, at least one transfer manifold communicating the intercooler with the power cylinders or to a compression chamber through which manifold the compressed charge is transferred to enter the power cylinders and/or compression chamber, an intake valve and in engine of FIG. 2, an outlet valve, the first valve controlling admission and the second valve controlling alternatively a partial recession of the compressed charge coming from the transfer manifold(s) to a compression chamber or said power cylinders through said intake valve and with said intake valve remaining open through piston BDC, closing during the compression stroke or process and in FIG. 2, the intake valve closing at the end of the intake stroke and said outlet valve opening at the end of the intake stroke allowing recession of a large portion of the cool air charge during an engine-cooling, charge-volume adjustment/compression (2nd) stroke in which—recessed cool air is pumped back, bathing internal engine components and then exiting through the intake/outlet or outlet valve through at least one intercooler to cool the recessed portion of air charge that has first cooled combustion chamber, the inlet/outlet or outlet and exhaust valves and that has now been recessed, and re-cooled and as said intake/outlet or outlet valve closes, capturing in combustion system (a) and (b) the volume of charge needed, when alternatively further compressed, fueled and ignited to power said engine, driving said piston or rotor lobe or vane in the power stroke, the recessed portion of charge, now gone, again cool, to said manifold and the said cooled exhaust valve controlling discharge of the exhaust gases from said power cylinders or rotor lobes or vanes after ignition and power stroke, the exhausted gases alternatively going through a conduit, an optional DPF (filter) passing into the inlet of a turbine which drives a turbo-compressor which exhaust gases alternatively then pass in-series through as many as three other turbines driving a like number of turbochargers.

For the engine of this invention, the intake/outlet and/or outlet valves of the power cylinders are timed to operate such that charge air which is equal to or heavier than normal can be maintained within the transfer manifold(s) when required and introduced into the compression chamber or power cylinder during the intake process or stroke thus filling the cylinder, with the intake valve of FIG. 1 remaining open during a portion of the compression stroke and then closing and with the intake valve closing at bottom dead center and outlet valve opening in FIG. 2 at piston bottom dead center position with the rising piston in engines of FIG. 1 FIG. 2, FIG. 4, FIG. 4B, FIG. 6 and FIG. 7, now pumping the entire cool air charge received back against the engine's hot internal components with a large portion then being recessed, exiting through the inlet/outlet valve of FIG. 1 and FIG. 4A or outlet valve of FIG. 2, FIG. 3 and FIG. 4, to an intercooler and storage manifold and alternatively, in combustion system (a) and (b), with the intake valves, now inlet/outlet valve, FIG. 1, or outlet valve of FIG. 2 then closing with piston or rotor lobe at some specific point during the compression process or stroke, to capture a specified volume of charge and alternatively to further compress the charge and then fuel, ignite and expand the charge against a piston or rotor vane or lobe to alternatively provide a low effective compression ratio. Alternatively the intake/outlet valve of FIG. 1 or recessed charge outlet valve of FIG. 2 is held open during the engine-cooling, charge-volume-adjusting/compression stroke, until from somewhere between 20% to 100% of the displaceable volume of the cylinder has been recessed, which portion of charge has already “bathed” and absorbed the heat from cylinder walls, combustion chamber, intake, outlet and exhaust valves whereby the heat is carried away and dispelled by the recessed charge now passing through one or more intercoolers as the recessed portion of the charge is returned, now again cool to the intake manifold. At the afore-said proper point in the alternative engine cooling, charge-quantifying/compression stroke in which the proper volume of charge required to produce needed engine power is reached the intake/outlet or outlet valve is closed trapping the properly quantified charge. In this combustion system any charge that is trapped outside of combustion chamber is then further compressed into the combustion chamber, alternatively producing a low effective compression ratio with the captured volume of charge air, or air-REG mix receiving fuel, it being injected at one or many points beginning at or after closure of intake/outlet or outlet valve, the charge is then ignited by spark or compression, alternatively, between 20 and 5° BTDC of piston, the exploding charge producing the power stroke followed by the scavenging stroke or process beginning at the opening of exhaust valve at near piston BDC for one complete power cycle for all reciprocating engines. In rotary engines, the rotor lobe or vane in the present power stroke drives the exhausted gases from the previous power pulse through the exhaust port.

In combustion system (b), with the air or air-REG charge prepared and presented the same as for combustion system (a) by inlet-outlet valve of FIG. 1 or inlet valve of FIG. 2, receiving the charge and at piston BDC, valve 16 of FIG. 1 remains open and in FIG. 2 engine at the intake stroke, valve 16i closes and outlet valve 16o opens at piston BDC and the cooling and charge-volume adjustment/compression stroke begins and valve 16 or 16o remains open to a non-selective but specified point during the engine cooling/compression stroke, until piston travel is somewhere between 80% and zero % of the displaceable volume of the cylinder, intake/outlet valve 16 or outlet valve 16o closes capturing the proper volume of charge specified, with the valve closing no later than 20-5° BTDC of piston position. At the point during the compression stroke that valve 16a or outlet valve 16o closes (FIG. 1, FIG. 2, FIG. 4, FIG. 6 and FIG. 7 and in FIG. 4A, valve v15), final compression on any charge trapped outside of the combustion chamber 5A begins and fuel is injected by fuel injector 24, FIG. 4, FIG. 4A and FIG. 4B, the fuel being fed by line 23, with injections for spark ignition alternatively beginning at closure of valve 16 or 16o or later, and the injections being single or in any number at any points before, at, or after charge ignition. For diesel ignition fuel is injected late in the compression stage in one or many injections into the combustion chamber then with the main injections being directly on the glow plug as shown in FIG. 4, FIG. 4A, FIG. 4B and the injections alternatively continuing into the early phase of combustion.

In combustion system (a) and (b), for engines of FIG. 1 through FIG. 5, the charge is alternatively ignited by spark or glow plug 25, shown in FIG. 4, FIG. 4A, FIG. 4B and for diesel ignition fuel is also injected directly onto glow plug 25, after first injection of several jets during late compression stage, followed by several jets of fuel during early combustion, with ignition beginning alternatively at between 20 and 5° BTDC of piston 22. The combustion charge volume trapped in cylinder 7 sets the effective compression ratio of the cylinder, or engine, which ratio for charge trapped in-cylinder and further compressed alternatively and preferably ranges approximately between 9:1 and 1:1. With inlet-outlet valve 16 or outlet valve 16o closing at 20-5° BTDC of piston 22, the charge receives little or no further compression—the effective compression ratio then being approximately 1:1, in both combustion systems (a) and (b). With the charge in combustion system (a) and (b), the charge is alternatively ignited at piston or combustion chamber position of 20-5° BTDC. The exploding gases depresses piston 22 into the power stroke and at approximately piston BDC, exhaust valve 17 opens, piston 22 driving the exhaust gas through conduit 18, through optional DPF and into intake of turbine 1 or to as many as four turbo chargers in series with each compression stage alternatively being precooled and/or intercooled by water or air cooling.

In combustion system (a) and (b), means are provided for causing fuel to be mixed with the air charge after closure of charge air inlet-outlet valve 16, outlet valve 16o, or v15, to produce a combustible gas-mixture as described herein, the charge is ignited alternatively at between 20-5° of crankshaft rotation angle before piston (BTDC), the exploding gases depressing the piston into the power (3^{rd}) stroke alternatively producing an expansion ratio greater than the compression ratio for a low “effective” compression ratio. At near piston BDC, the exhaust valve(s) open and the scavenging (4^{th}) stroke occur. This completes one power cycle for combustion systems (a) and (b) for engine of FIG. 1, FIG. 2, FIG. 4, FIG. 4A, FIG. 4B and FIG. 5, in conjunction with the additional embodiments shown and described for FIG. 4, FIG. 4A, FIG. 4B, FIG. 5, FIG. 6 and FIG. 7.

The chief advantages of the present invention over the existing ICE are that it alternatively cools combustion chamber, charge intake and outlet valves and the exhaust valve after each firing-power and exhaust stroke have occurred, and it also provides an effective compression ratio lower than the expansion ratio of the engine and provides selectively, a mean effective cylinder pressure higher than the conventional engine arrangement with the same or lower maximum cylinder pressure than that of prior art engines.

This allows greater fuel economy and production of greater power and torque at all RPM, with low polluting emissions. Because charge densities, temperatures, volume and pressures are managed, and engine internal components are cooled, light-load operation is practical even for extended periods, with no sacrifice of fuel economy. The new working cycle is applicable to all 4-stroke engines, both spark-ignited and compression-ignited as well as HCCI operation. For spark-ignited engines, the weight and density of the charge can be greatly increased without the usual problems of high peak temperatures and pressures with the usual attendant problem of combustion detonation and pre-ignition. For compression-ignited engines, the heavier, denser, cooler, more turbulent charge provides low peak cylinder pressure for a given expansion ratio and allows richer, smoke-limited air-fuel ratio, giving increased power and torque with lower particulate and NOx emissions and produces less noxious odor. Alternatively, all designs are fitted with diesel particulate filters (DPF) on exhaust conduits upstream of alternative dual REG systems. Compression work is reduced due to reduced heat transfer during the compression process. Engine durability is improved because of an overall cooler working-cycle and because of lower RPM, the latter allowed by greater torque.

Additional novel embodiments described and illustrated for FIG. 5 are useful in any reciprocating engine as specified herein especially for the engines of FIG. 1, FIG. 2 FIG. 4, FIG. 4A, FIG. 4B, FIG. 6 and FIG. 7, which technology provides for double the normal burn time and much greater torque, both embodiments being controllably variable in the degree of improvements desired.

All of the objects, features and advantages of the present invention cannot be briefly stated in this summary, but will be understood by reference to the following specifications and the accompanying drawings.

The preferred embodiments of the engine of this invention are shown and described for the engine of FIG. 2, FIG. 4, FIG. 4B, FIG. 5, FIG. 6 and FIG. 7 which are very similar in structure to that of FIG. 1 and FIG. 4A the main exception being use of novel cross-flow heads in the other designs, in that the cooled charge air is delivered to the combustion chamber and cylinder(s) 7x of the engines of FIG. 2, FIG. 4, FIG. 4B, FIG. 5, FIG. 6 and FIG. 7 by way of inlet conduit 16ai, intake valve 16i, on the intake stroke of the piston 22, the intake valve 16i being open through the intake stroke is then closed at piston BDC and then at piston 22 turn-around at BDC recessed charge outlet valve 16o opens and as piston 22 begins its engine-cooling, charge-adjustment/compression stroke, the portion of charge being recessed is dashed upward against the optional concave face of the exhaust valve 17e head (FIG. 4), against intake valve 16i head, the combustion chamber in its journey through outlet valve 16o. The charge which has now bathed all of the components said above has now received and removed much of the heat produced in these components from each immediate prior firing and power and exhaust stroke. This heat is now carried by the portion of charge recessed and dispelled, before closure of outlet valve 16o, of which the volume can be as small as 20% or as much as 100% of the displaceable volume of the cylinder 7, going through outlet valve 16o before its closure, then out conduit 15ao, air or liquid cooled intercooler 14C; the now re-cooled, recessed charge going back to manifold 13. In combustion system (a) and (b), the outlet valve 16o had closed at a specified point in the charge-adjusting/compression stroke ending the recession and exiting of surplus charge and trapping the volume of charge necessary that when further compressed, fueled and fired, to power the engine. The volume of charge trapped in the cylinder 7x can be alternatively be anywhere between 80% and zero % of the displaceable volume of cylinder 7x while operating in combustion systems (a) or (b), with combustion system (a) providing for selection variation in “effective” compression ratios.

Operating in combustion system (b), the charge volume trapped is non-selective and is any percentage of the displaceable volume of the cylinder not yet displaced at the closing of the outlet valve 16o.

At the closing of outlet valve 16o in FIG. 2, any charge volume that was trapped outside of combustion chamber 5A in combustion system (a) or (b), is further compressed into combustion chamber 5A, fuel is injected by fuel injector 24, see FIG. 4, into the combustion chamber 5A at one or many points in piston travel after outlet valve 16o closure until the piston reaches the point that the charge is ignited, which occurs alternatively at between 20 and 5° BTDC of piston 22 position and also is alternatively injected during early combustion process. For diesel operation fuel is alternatively injected late in the compression stroke, near piston TDC and alternatively the main fuel charge is there injected into the combustion chamber and alternatively directly on glow plug 25 if present, by fuel injector 24, approximately at between 20-5° BTDC of piston 22 and also is alternatively lightly injected during early combustion. In combustion system (a) or (b) with any fuel, the charge is alternatively ignited at 20-5° BTDC, by compression, HCCI, spark or glow plug 25, FIG. 4 producing the power stroke followed by the exhaust stroke, thus completing one working cycle in combustion system (a) or (b).

Because natural gas has a higher ignition temperature than diesel—1472° F. compared to 932° F.—for the engines of this invention, liquefied or compressed natural gas or hydrogen preferably and alternatively is ignited by diesel fuel which is injected in small amounts just prior to piston TDC, followed by the main fuel quantity of natural gas or hydrogen, the charge being ignited just prior, 5 to 20° BTDC, by compression heat, aided alternatively by glow or spark plug.

Alternatively, hydrogen is ignited by electric spark plug 24.

For the engine of FIG. 4A, the cooled air or AIR-REG charge is received by inlet/outlet valve V15 on the intake stroke of piston 22, with the cooling portion of the charge returning through inlet/outlet valve V15 going to cooler 4C and manifold 13 by way of conduit 15ao, with valve V15 then closing to capture proper volume of charge for engine operation.

In combustion system (a) or (b) and with engine of FIG. 4B, with outlet valve 16o closing just prior to or between 20-5° BTDC of piston, being fueled and injected as specified herein, the effective compression ratio is approximately 1:1. When trapping and further compressing any charge before ignition by closure of outlet valve 16o in combustion system (a) and (b), alternatively and ideally produces “effective” compression ratios of between approximately 9:1 to 2:1.

Another preferred combustion system is shown and described for engine of FIG. 6, which combines the system of FIG. 2 and FIG. 4 and alternatively with the embodiments of FIG. 5 with the pre-combustion system shown and described for engine of FIG. 2 combined with and in conjunction with the sixth embodiment described and shown in FIG. 6 with ignition occurring in the precombustion chamber 38′ system, as piston 22 with fuel being present in precombustion chamber 38′, compresses air charge through ports 4, into precombustion chamber 38′ after closure of outlet valve 16o in the compression stroke, the charge is ignited by glow or spark plug 37 at 20-5° BTDC, with the roiling fire spreading to combustion chamber 38 which was optionally alternatively supplementary fueled by the fuel injector 24, FIG. 4, during the compression stroke after the closure of outlet valve 16o, the compound exploding charge expanding and driving piston 22 in the power stroke, followed by the exhaust stroke. Alternatively, the ideal effective compression ratio produced ranges between 9:1 to 1:1, the latter when only the charge volume of combustion chamber 38 plus that of precombustion chamber 38′ which has received no further compression, is ignited.

In operating in the combustion system (b) the presentation and treatment of the charge by engine of FIG. 2 utilizing precombustion chamber 38′ is the same as for system (a), except that during the second stroke, charge outlet valve 16o opens, and remains open, non-selectively to a point between 20-100% of displaced volume of charge is recessed and the outlet valve 16o then closing always constantly at the same point, but no later than at between 20 and 5° BTDC, thus from somewhere between 80 and zero % of the clearance volume of the cylinder and with supplementary fuel being injected into combustion chamber 38 proper, by fuel injector 24, FIG. 6 at one or many points after closure of outlet valve 16o, with any charge remaining in cylinder outside the combustion chamber 38 after closure of valve 16o being further compressed into combustion chamber 38 and precombustion chamber 38′ and is ignited at between 20-5° BTDC, producing the power stroke, followed by the exhaust stroke of piston 22 thus completing one power cycle in combustion system (b) for the engine of FIG. 2 alternatively in conjunction with the embodiment of FIG. 4, FIG. 5 and FIG. 6. (If outlet valve 16o closes as late as 20-5° BTDC of piston 22, only the volume of combustion chamber 38 plus the volume of precombustion chamber 38′ is captured and with no further compression, the charge is ignited in precombustion chamber alternatively at 20-5° BTDC, the flame spreading to combustion chamber 38, producing an effective compression ratio of approximately 1:1.) The latter, with low effective compression ratio is practical using extremely high charge pressures.

Alternatively different fuels are injected by injectors 37 and 24. For example, diesel fuel is injected into precombustion chamber 38′ and ignited by aid of glow plug 37 with main fuel which is supplementary is compressed or liquefied natural gas or any other fuel which has a higher ignition temperature than that of diesel oil, is injected into combustion chamber 38 proper after outlet valve 160 or v15 is closed during the compression stroke. The plasma-like blast of flame roiling into combustion chamber 38 proper igniting the bottom charge causing a more complete “burn”, possibly in conjunction with extended burn-time of embodiment described for FIG. 5.

### BRIEF DESCRIPTION OF THE DRAWINGS

Embodiments of internal combustion engines (ICE) according to the invention will now be described, by way of example, with reference to the accompanying drawings, in which:

FIG. 1 is a perspective view (with portions in cross-section) of the cylinder block and head of a six-cylinder ICE operating in a 4-stroke cycle, and representing a first embodiment of the apparatus of the present invention from which a first method of operation can be performed and will be described. Among its other components, this design is seen as having at least one ancillary compressor, a second compressor, a cooling system encompassing five intercoolers, an engine control module, valves and conduits to control charge pressure, density and temperature of the charge air and to control the temperature of the internal components of the engine. Other components are an embodiment composed of a charge induction system composed of optional dual intake manifolds, conduits and valves which inducts an air or air-REG charge into a cylinder, alternatively recesses any excess portion of the charge, which portion cools engine components and then returns the expelled portion of the charge to the intake manifold by the same route as to the combustion chamber, hence, passing the recessed charge air through an air or liquid cooled intercooler where the heat that was collected from cylinder walls, combustion chamber, intake/outlet valve, is now dispersed, the recessed portion of charge now cooled returning to intake manifold. Also shown are two alternate systems for providing REG to the combustion chambers and also shown on the exhaust conduits is a diesel particulate filter (DPF) upstream of the alternative REG systems. Shown also is an engine control module which is electrically operated and in conjunction with various sensors and activator servo systems, controls all variables of the engine.

FIG. 2 is a schematic drawing with some in cross-section of a six-cylinder ICE, similar to the engine of FIG. 1 operating in a 4-stroke cycle and representing a second embodiment of the apparatus of the present invention from which a second method of operation can be performed and will be described. Among its other components, this system is seen as having two compressors, five intercoolers, ten control valves, dual intake manifolds, bypass paths and valves for both the primary compressor and the ancillary compressor and intercoolers, the manifolds conveying charge air or air-REG to combustion chambers by way of intake valves to cylinders, an embodiment composed of outlet valves to return excess charge to manifold and showing a means of controlling charge-air densities, pressures and temperatures and an ancillary means of cooling said combustion chambers, pistons, intake, outlet and exhaust valves alternatively after each firing-power, exhaust and intake stroke, using a cross-flow head for returning heat-absorbed recessed air charge through an outlet valve and through a different conduit fitted with intercoolers 13C and 14C, cooled by water or air, where the heat collected from the components of the engine after firings is dispersed with the expelled portion of charge air now again cooled by going through intercoolers 13C and 14C, the cool charge then returning to the manifolds 13 and 14.

FIG. 3 is a cross section of a drawing of a partial cylinder head of the ICE of FIG. 2 and components thereof in FIG. 4, representing a third embodiment of the apparatus of the present invention from which a third method of operation can be performed and will be described. Among its other components, this embodiment is seen as having a power cylinder 7x, representing any power cylinders of the engine of FIG. 2 with or without other complementary embodiments and other designs of this invention, in which the head of cylinder 7x shows alternatively the intake valve 16i and recessed-charge outlet valve 16o which are so arranged that in receiving and exiting a cooling portion of the charge forms a Cross-Flow embodiment so that an exhaust valve 17e is situated between the charge inlet valve 16i and charge-recessing outlet valve 16o, the exhaust valve 17e having an alternative concave head (shown in FIG. 4), in order to impart its heat to the cool air charge which fills cylinder 7x on the intake stroke of piston 22, not shown but seen in FIG. 4 and the said outlet valve 16o, which during the engine-cooling, charge-volume-adjusting/compression (2^{nd}) stroke, recesses a major portion of the charge after it has been pumped, roiling against the concave face of the valve head 17e and other hot engine components such as piston, cylinder walls, inlet and outlet valves and then out through said outlet valve 16o, and through intercooler 13C and 14C shown in FIG. 2, the charge now re-cooled and directed to intake manifolds 13 and 14, FIG. 2, for further use.

FIG. 4 is a part sectional view through components described but not clearly shown in the ICE of FIG. 2, representing the fourth alternate embodiment of the apparatus of the present invention from which arises and better illustrates the fourth method of operation that can be performed and will be described. This embodiment is seen as having an engine head and block 100², a cylinder 7x, piston 22, an exhaust valve 17e with exhaust conduit 18a which exhaust valve is representative of any exhaust valve of this invented ICE of FIG. 2 and other designs of this invention, the valve 17e alternatively having a valve head situated between charge inlet valve 16i and recessed-charge outlet valve 16o said valve heads alternatively arranged with concave shaped face of the heads whereby between each firing-power and exhaust stroke, cool charge air enters intake valve 16i, fills cylinder 7x on intake stroke with intake valve 16i closing and outlet valve 16o opening at piston BDC and on the beginning of the compression stroke, with inlet valve 16i closed, the power piston 22 pumps the cool recessed charge up against the engine head and into the hot concave-shaped heads of exhaust valve 17e and the adjacent valves, absorbing much of the heat into the charge air and now outlet valve 16o recesses and expels all of the charge not needed for power through outlet valve 16o, (thus utilizing the Cross-Flow combustion first shown and described for FIG. 3) and then closes valve 16o capturing and then further compressing a specified volume of charge required that after fueling and igniting to power the engines, the recessed charge-air or air-REG portion having then gone through conduit 15ao, intercooler 14C and then returned the now re-cooled charge air to intake manifold 13 for further use. Also shown in FIG. 4 are fuel injector 24, spark or glow plug 25, combustion chamber 5A, exhaust conduit 18a and exhaust port 18b.

FIG. 4A is a part sectional view through one cylinder of an engine of this invention similar to engine of FIG. 4, but illustrating and describing an alternate means of induction of charge air and abducting recessed cooling charge air through the same valve having an arrangement whereby the charge enters cylinder 7x by way of conduit 16ai, two-way valve V15 on the intake stroke, valve V15 closing by rotation of 2-way valve V15 ports near or at piston BDC. The port from conduit 16ai to cylinder 7x by way of valve V15, alternatively closes at piston 22 BDC and valve V15 opening a port to conduit 15ao at near piston BDC, by which any excess combustion charge is recessed and directed to conduit 15ao, going through intercooler 14C and then returned cooled to intake manifold 32 during a portion of the third stroke of piston 22. In the passing of the portion of recessed charge through outlet port of two-way valve V15 this valve is closed-off at a specified point or time in order to trap a proper volume of charge required to power the engine of FIG. 4A and FIG. 1, with the retained volume of charge then alternatively further compressed, fuel is added and the fuel is ignited alternatively at 20-5° BTDC of piston 22.

The operation of the engine of FIG. 4A is in all respects the same as that specified for the engines of FIG. 1 and FIG. 4 with the exception that the charge Cross-Flow system is not specified for the engine of FIG. 4A.

FIG. 4Ai is a cross-section of the inlet/outlet valve of FIG. 4A showing a means of inducting charge into cylinder 7x through 16ai and then closing the incoming charge off at piston BDC.

FIG. 4Ao is a cross-section of two-way valve 15A showing how at piston BDC the incoming charge is stopped and diverted out through valve V15 and through conduit 15ao. It also shows that rotating valve V15 another 30 degrees or so, captures any charge contained in cylinder 7x for further compression of charge after which time the retained charge is fueled, if fuel is not present and when piston position is alternatively between 20-5° of TDC, the charge is ignited by spark or compression. Shown also in FIG. 4A is a fuel injector 24, spark or glow plug 25 with fuel lines 23.

FIG. 4B is a part sectional view through alternate components not shown in the ICE of FIG. 4, but which components shown here and described, with FIG. 4B herewith representing the fifth alternate embodiment of the apparatus of the present invention (also useful in any reciprocating engine whether the engine is present technology or new) from which drawing arises and better illustrates the fifth method of operation that can be performed and will be described. This embodiment 22C is seen as having an extended reactive area of exposed piston crown with the engine head being conformed to the shape of the piston crown with the slope of the piston head as it slopes from alternative flat “LANS” 22A surrounding the base of piston crown 22C having a constant degree of slope from the LANS to near piston crown top and with the proper space for the combustion chamber above the piston crown. The greater surface area of the piston head that is exposed provides greater power at normal, greater than normal, or lower than normal compression ratios and is also useful in homogeneous compression ignition (HCCI) operation. This drawing is also shown as having all of the other components shown in FIG. 4, an engine head and block 100², a cylinder 7x, piston 22, now piston 22b, piston crown 22C, fuel injector 24, spark or glow plug 25, an exhaust valve 17e with exhaust conduit 18a which exhaust valve 17e is representative of any exhaust valve of this invented ICE of FIG. 1, FIG. 2, FIG. 4, FIG. 4B, FIG. 5, FIG. 6 and FIG. 7 and other designs of this invention, the valve 17e alternatively having its valve head situated between charge inlet valve 16i and recessed-charge outlet valve 16o, said valve heads alternatively arranged with concave shaped face of the heads whereby between each firing-power and exhaust stroke, cool charge air enters intake valve 16i, fills cylinder 7x on intake stroke with intake valve 16i closing and outlet valve 16o opening alternatively at piston BDC and on the beginning of the compression stroke, with inlet valve 16i closed, the power piston 22 pumps the cool recessed portion of charge up against the engine head and into the hot concave-shaped heads of exhaust valve 17e and the adjacent valves, dispelling much of the heat into the charge air and now outlet valve 16o recesses and expels all of the charge not needed for power through outlet valve 16o, then closes valve 16o capturing for further compression, a specified volume of charge required that after further compression, fueling and igniting, to power the engine, the recessed charge-air or air-REG then going through conduit 15ao, intercooler 14C and then returns the now re-cooled charge air to intake manifold 13 for further use.

FIG. 5 is a part sectional view through one cylinder of an engine of this invention representing fifth and sixth alternate embodiments of the apparatus of the present invention showing a means of (5) providing extra burn time at ignition and combustion in a 4-stroke ICE, including the engine of this invention, shown in FIG. 4, FIG. 4B, FIG. 6 and FIG. 7 and (6) also representing the sixth alternate embodiment of the apparatus of the present invention, shown in FIG. 4, and showing a means of greatly increasing engine torque, which alternate embodiments can be performed and will be described showing a means by which both systems alternatively also provide a controllably variable degree of improvement in performance of these embodiments and are useful in the engines of this invention including FIG. 1, FIG. 2, FIG. 4, FIG. 4A, FIG. 5, FIG. 6 and FIG. 7 and also useful to any other reciprocating ICE.

FIG. 6 is a part sectional and schematic view through one component of the ICE of this invention shown in FIG. 2, representing the seventh alternate embodiment of the apparatus of the present invention that better illustrates the seventh method of operation that can be performed and will be described. This embodiment is seen as having an engine head and block and combining a pre-combustion chamber 38′ for primary fuel ignition, a fuel supply line 36 and check valve 1, a spark plug 37, two ancillary fuel inlet valves, a second fuel inlet duct, a combustion chamber 38, a charge inlet valve 16i and port 16pi, a recessed-charge outlet valve 16o and port 16po, an exhaust valve (not shown but which valve is shown in FIG. 4), a cylinder 7x, two fuel inlet conduits 36 and a piston with connecting rod (not shown), an inlet conduit from 114 of FIG. 2, to an intake manifold 13 of FIG. 6, one charge inlet conduit 16ai and intake valve 16i, leading to the said combustion chamber proper 38 and cylinder 7x, a fuel injector 24 for alternatively injecting an ancillary fuel charge, (which fuel is alternatively the same type of fuel, or is a different type of fuel as that injected into precombustion chamber 38′), into combustion chamber proper during the compression stroke, one alternative conduit 15ao leading from the combustion chamber to an intercooler 14C, the intercooler and conduit 15a conveying any charge recessed, now again cool, back to the aforementioned intake manifold.

FIG. 7 is a part sectional and schematic view through one component of the ICE of this invention shown in FIG. 2, representing the eighth alternate embodiment of the apparatus of the present invention that better illustrates the eighth method of operation that can be performed and will be described. This embodiment is seen as showing an engine head and block 100² and combining a pre-combustion chamber 38′, a fuel injector 24P, a second fuel injector 24, a glow plug 37, two ancillary fuel inlet valves I″, 28, two fuel inlet ducts 23, 23′, a combustion chamber proper 38, a charge inlet valve 16i and port 16pi, a recessed-charge outlet valve 16o and port 16po, an exhaust valve (not shown but which valve is shown in FIG. 4) a cylinder 7x, two fuel inlet conduits 36, 24 and a piston 22, with connecting rod not shown, an inlet conduit from 114 of FIG. 2, to an intake manifold 13 of FIG. 7, one charge inlet conduit 16ai and intake valve 16i leading to the said combustion chamber proper 38 and cylinder 7x, a second fuel injector 24 for optionally and alternatively injecting fuel into combustion chamber proper during the compression stroke, one alternative conduit 15ao leading from the combustion chamber to an intercooler 14C, the intercooler and conduit conveying any charge recessed, now again cool, back to the aforementioned intake manifold.

### DETAILED DESCRIPTION OF THE DRAWINGS AND METHOD

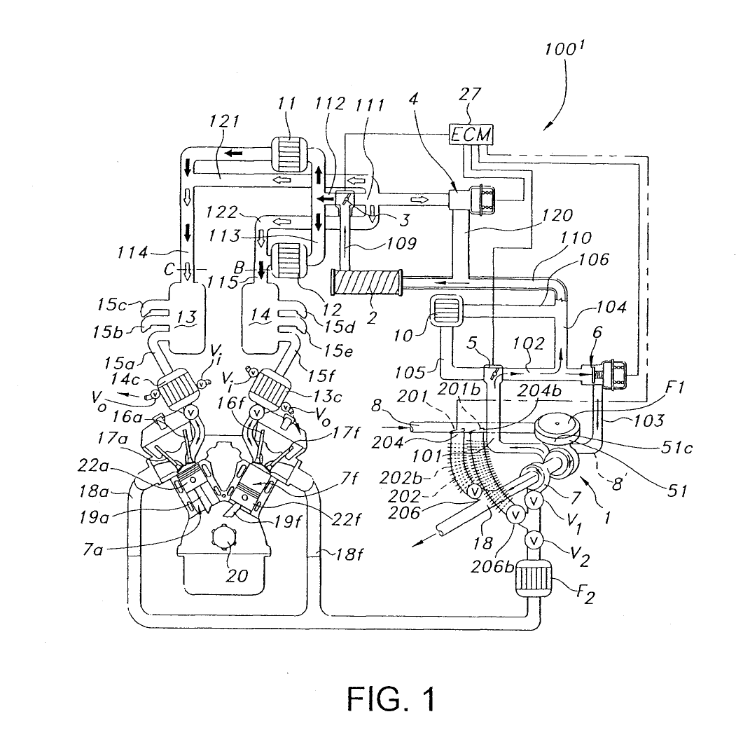

With reference now in greater detail to the drawings, a plurality of alternate preferred embodiments of the apparatus of the improved internal combustion engine 100 of the present invention are depicted. Like components will be represented by like numerals throughout the several views; and, in some but not all circumstances, as the writer might deem necessary similar but alternate components will be represented by superscripted numerals (e.g., FIG. 1). When there are a plurality of similar components, the plurality is often times referenced herein (e.g. six cylinders 7a-7f), even though fewer than all components are visible in the drawing. Also, components which are common among multiple cylinders are sometimes written with reference solely to the common numeral, for ease of drafting—e.g., piston 22a-22f=>piston 22. In an effort to facilitate the understanding of the plurality of embodiments, (but not to limit the disclosure) some, but not all, sections of this Detailed Description are sub-titled to reference the system or sub-system detailed in the subject section.

The invented system of the present invention is, perhaps, best presented by reference to (1) the method(s) of cooling of combustion components; (2) of managing combustion charge densities, volumes, temperatures, pressures and turbulence; (3) providing low effective compression ratios; and the following description attempts to describe the preferred methods of the present invention by association with and in conjunction with apparatuses configured for and operated in accordance with the alternate, preferred methods.

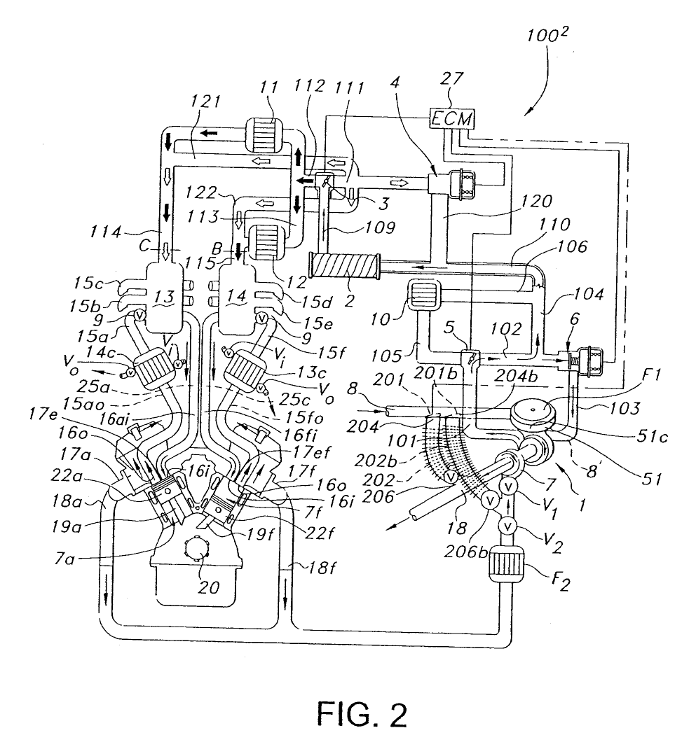

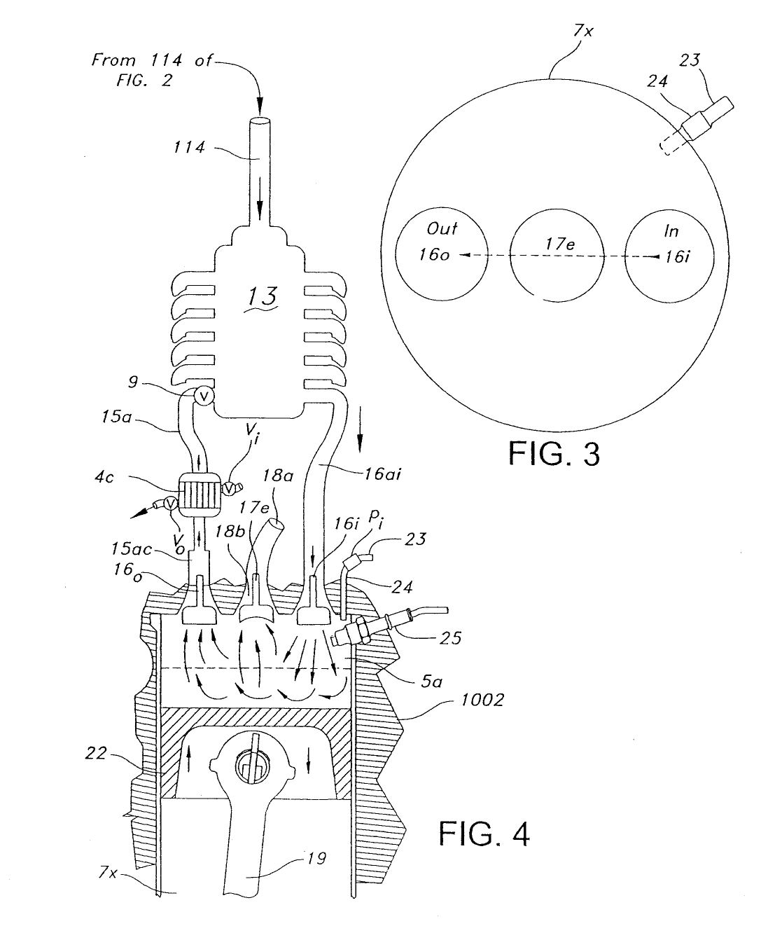

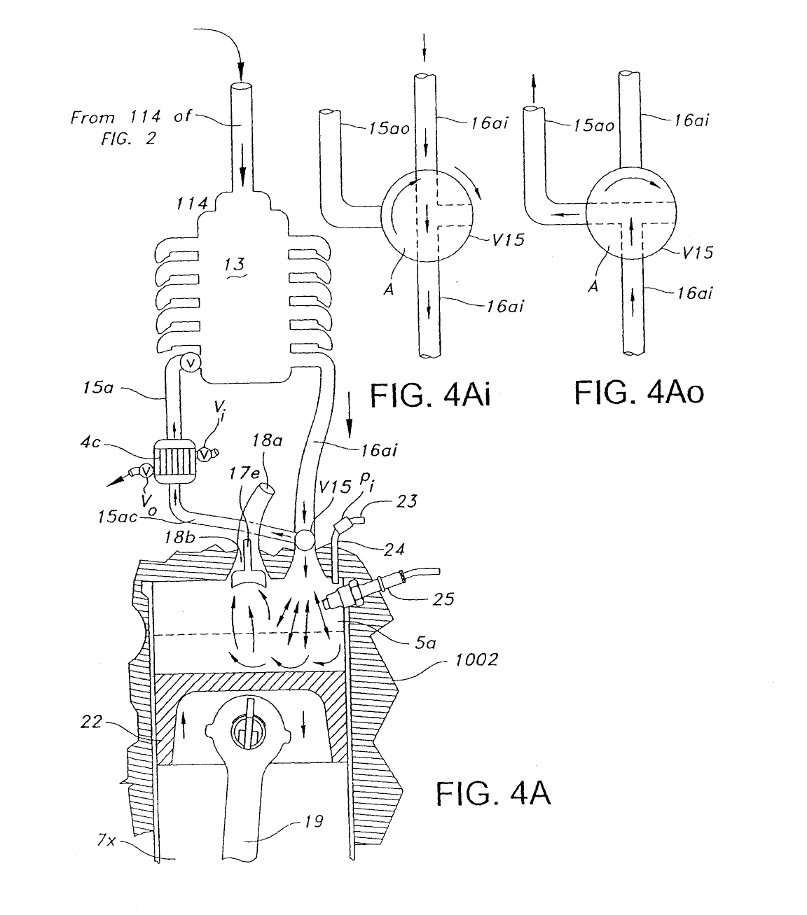

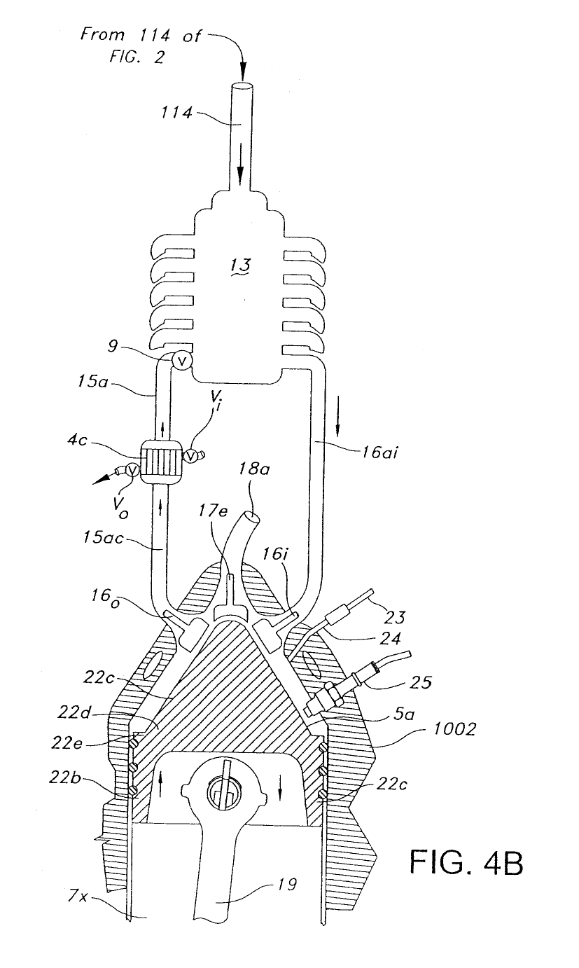

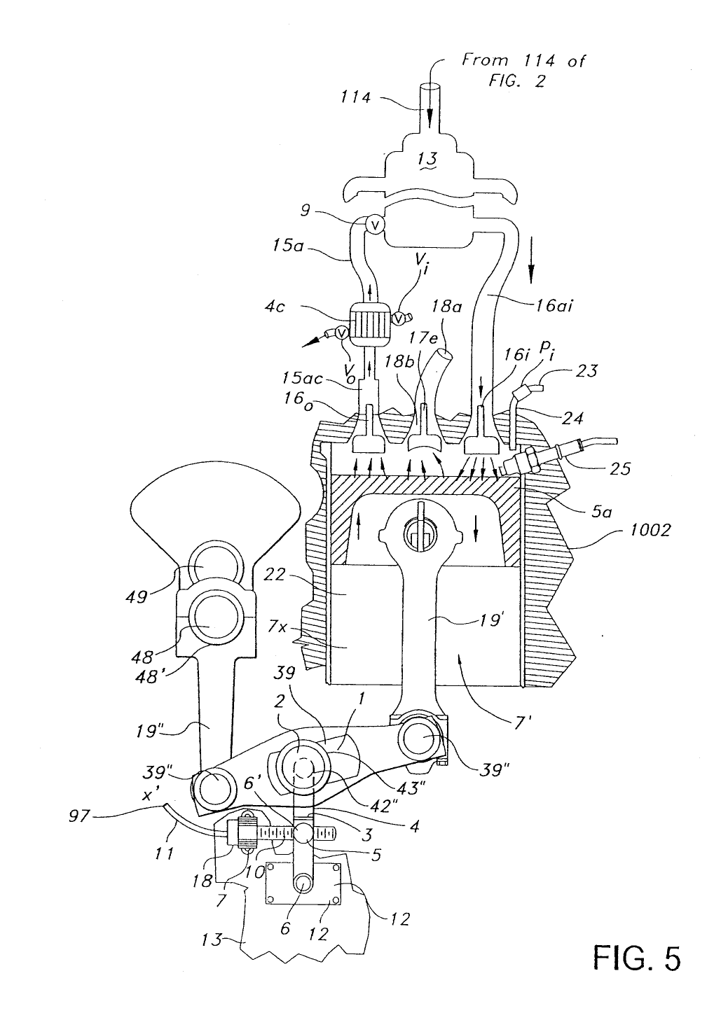

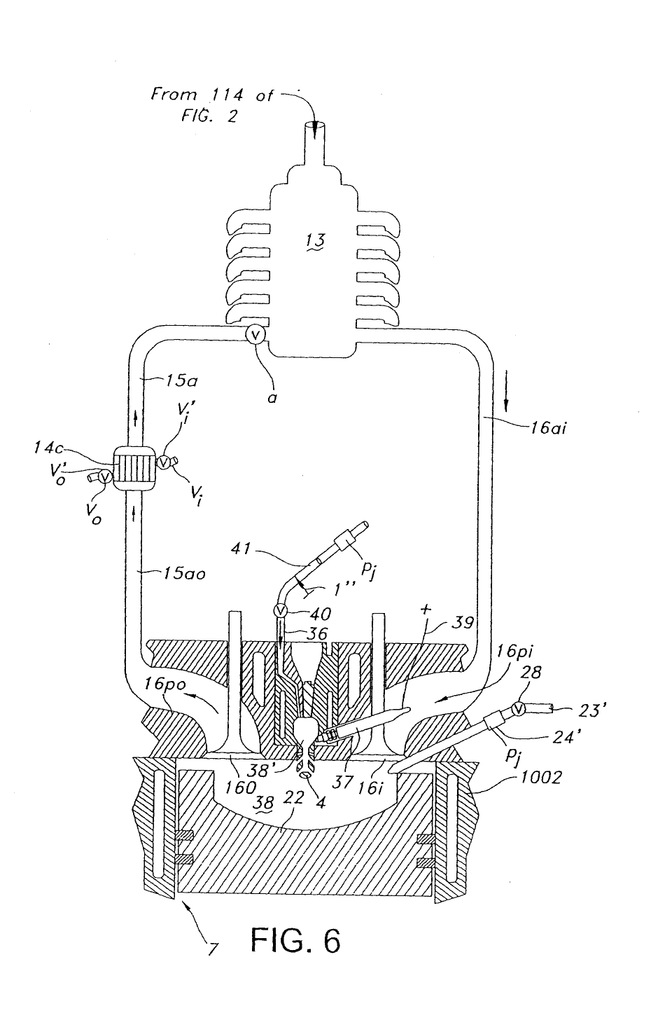

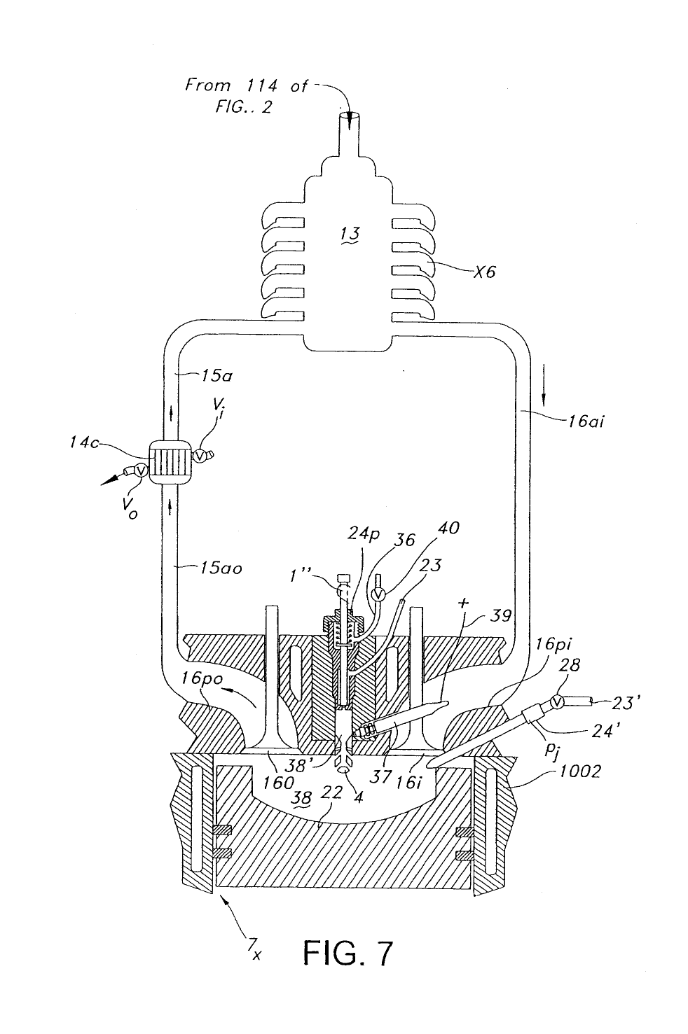

Some, but not necessarily all, of the system components that are common to two or more of the herein depicted embodiments include a crankshaft 20, to which are mounted connecting rods 19a-19f, to each of which is mounted a piston 22a-22f, each piston traveling within a power cylinder 7a-7f; air or air-REG mix being introduced into the cylinders through inlet ports controlled by intake valves 16a-16f, (shown in FIG. 1) and by valves 16i, shown in FIG. 2, FIG. 4, FIG. 6 and FIG. 7 and by a single two-way valve V15 shown in FIG. 4A, and before the closing of the intake valve, any portion of the charge in excess of that required to power the engine is expelled through inlet-outlet valve 16 for engine of FIG. 1, through inlet-outlet valve V15 of engine of FIG. 4A, out through outlet valve 160 for engines of FIG. 2, FIG. 4, FIG. 4B, FIG. 5, FIG. 6 and FIG. 7 and exhausted gases being exhausted from the cylinders through exhaust ports 18b shown in FIG. 4 and FIG. 4B controlled by exhaust valves 17 (shown in FIGS. 4, 4B). The interaction, modification and operation of these and such other components as are deemed necessary to an understanding of the various embodiments of the present invention are expressed below.

### Detailed Description and Operation

### The Engine 100¹ of FIG. 1

Referring now to FIG. 1, there is shown a six cylinder reciprocating ICE 100¹ which all of the cylinders 7a-7f (only two of which are shown in a sectional view) and associated pistons 22a-22f operate in a 4-stroke cycle and all power cylinders are used for producing power to a common crankshaft 20 via connecting rods 19a-19f, respectively. Alternatively a primary compressor 1, driven by exhaust turbine 7, receives atmospheric air or alternatively air and recirculated exhaust gases (REG) through conduit 8, alternatively filters the air and/or REG through filter F1, compresses the air, or air-REG by at least one compressor 1, accordingly as allowed by waste gate V1, as directed by controls activated by engine control module 27 (ECM-27) to a precooler and/or intercooler 10 and to an ancillary compressor 2 (herein depicted as a Lysholm rotary compressor) selectively further compresses and supplies the air or air-REG which has been compressed and then cooled, to manifolds 13 and 14 and to cylinders 7a-7f which cylinders operate in a 4-stroke cycle. Valves 3, 5 and 6, controlling compressors 1 and 2 and intercoolers 10, 11, 12, 13C and 14C which are used, in the preferred embodiments, to control air charge density, weight, temperature and pressure and to provide cooling of engine components. The intake valves 16a-16f are timed to control the effective compression ratio of the engine 100¹ of FIG. 1, as does intake valve 16i and outlet valve 16o for engines of FIG. 2, FIG. 4, FIG. 4B, FIG. 6 and FIG. 7 and valve V15 which is a two-way valve for both induction and eduction of charge air for engine of FIG. 4A. The combustion chambers of cylinder 7a-7f and power cylinder 7x are sized to establish the expansion ratio of the engine. Conduits 15a-15f and intake valves 16a-16f in FIG. 1 deliver combustion air to combustion chambers and cylinders 7a-7f and allow passage of all recessed air charge back through the same valves and conduits in which there are situated intercoolers 13C and 14C which recessed (expelled) charge passes through and now cooled again, travels to intake manifold 13 or 14. Also shown are two transfer conduits 202-202b and their associated valves capable of transferring REG from either port 206 or alternatively port 206b, with the REG gases, cooled or alternatively un-cooled, to fresh air intake 8 and filter F1, the exhaust gases coming alternatively from port 206 which is downstream from turbine 7 or alternatively from port 206b which port is on exhaust conduit 18 which is upstream from turbine 7 and downstream from optional diesel particulate filter (DPF) F2, as also REG port 206 is downstream of filter F2, which filter alternatively filters any exhaust gases passing through exhaust conduit 18, whether going to engine air intake or to drive turbine 7, or to the atmosphere.

The engines 100¹ of FIG. 1 and also 100² of FIG. 2, FIG. 4, FIG. 4A, FIG. 4B, FIG. 6 and FIG. 7, respectively, have camshafts (not shown), fitted with cams and are arranged to be driven at one-half the speed of the crankshaft in order to supply one power stroke for every two revolutions of the crankshaft for each power piston 22a-22f. The rotary compressors 2 of FIG. 1 and FIG. 2 are alternatively driven by a ribbed V-belt and alternatively have a step-up gear between the V pulley and the compressor drive shaft. The rotary compressors alternatively are also fitted with a variable-speed step-up gear as are some aircraft engines. Alternatively, the compressor system has multiple stages, preferably, as many as four or more stages of compression and cooling using either turbine rotary or reciprocating compressors. Whereas, the compressor 1 and ancillary compressor 2 of the various embodiments are depicted throughout as rotary compressors, it is noted that the invention is not limited by the type of compressor utilized for each; and the depicted compressor types may be interchanged, or may be the same, or may be other types of compressors performing the functions described herein. Turbo compressors are specified in numbers of one to four, preferably arranged in-series and intercooled.

The engines 100¹ shown in FIG. 1, and 100² shown in and for FIG. 2, FIG. 4, FIG. 4A, FIG. 4B, FIG. 6 and FIG. 7, are characterized by providing a more extensive expansion process, a low effective compression ratio and the capability of producing a combustion charge varying in weight from normal to heavier-than-normal, and capable of selectively providing a mean effective cylinder pressure higher than can the conventional arrangement of normal engines but having similar or lower maximum cylinder pressure in comparison to conventional engines. An engine control module (ECM-27) and variable valves 3, 4, 5 and 6 on conduits, as shown, provide a system for controlling the charge density, pressure, temperature, turbulence and the mean and peak pressure within the cylinder which allows greater fuel economy, production of greater torque and power at low RPM, with low polluting emissions for both spark and compression-ignited and HCCI engines. Charge intake/outlet valves 16 of engine of FIG. 1, and intake and outlet valves 16i, 16o of engine of FIG. 2, FIG. 4, FIG. 4B, FIG. 6 and FIG. 7, and intake/outlet, two-way valve V15 of engine of FIG. 4A, in concert with intercooler(s) 13C or 14C, provide a cooling system for engine components as well as for supplying quantified weight and density of charge air or air-REG which is volume-adjusted and alternatively further compressed and is sent to the engine combustion chamber. Alternatively a variable valve timing system is used and, with a control system such as an engine control module (ECM-27) and accompanying servo systems and with appropriate sensors, controls the time of opening and time of closing of the intake and outlet valves 16, intake valve 16i and outlet valve 16o, and intake/outlet valve V15, to further provide an improved management of conditions in the combustion chambers of cylinders 7a-7f of the engines 100¹ of FIGS. 1 and 100² of FIG. 2, FIG. 4, FIG. 4A, FIG. 4B, FIG. 6 and FIG. 7, to allow for greater torque and a flatter torque curve and higher power and with low levels of fuel consumption, polluting emissions and noxious odors.

### Brief Description of Operation of the Engine 100¹ of FIG. 1

Referring again to FIG. 1, the engine shown in FIG. 1 is a high efficiency engine that attains both high power and torque with low fuel consumption and low polluting emissions. The new working cycle is an external compression type combustion cycle. In this cycle, the intake air or air-REG is pre-compressed, selectively, by at least one ancillary compressor 1, with charge cooling further compressing occurring before charge ignition in combustion systems (a) and (b), the charge volume in combustion system (a) being infinitely selective and in system (b) the range of the possible charge volume utilized is the same as that of system (a) although the charge volume can be similar but the volumes are non-selective, with power and speed of the latter engine being varied by varying density and pressure of charge and by varying quantity of fuel input. The temperature rise during compression and post firing can be suppressed by use of air coolers 10, 11, 12, 13C and 14C which cool the intake air before firing and alternatively the engine components after each firing stroke and also by a very low effective compression ratio.

One suggested preferred method of operation of the new-cycle engine 100¹ of FIG. 1 is thus:
1. Depending upon the power requirements of the engine (e.g., differing load requirements), after each combustion firing, power stroke and exhaust stroke, intake air that has been compressed by at least one ancillary compressor and has had its temperature and pressure adjusted by bypass systems and charge-air coolers, is drawn into the power cylinder 7 by the intake stroke of piston 22, the cool air charge entering cylinder 7 by way of conduit 15 and intake/outlet valve 16.
2. (a) After the intake stroke is complete, the intake/outlet valve 16 (which can be single or multiple) is left open for a period of time after cylinder 7 is filled and the piston 22 has passed bottom dead center which alternatively then pumps with power and speed, the cool fresh air charge, roiling back against combustion chamber, exhaust valve, intake and outlet valve, then expelling a large portion of the charge back through valve 16 and now passing it through intercoolers 13C and 14C and then back into the intake manifold 13 and 14.
   In combustion system (a), the intake valve 16 closes at a point which interrupts the flow of recessed charge air going out through valve 16 and which action also seals cylinder 7, capturing a specific volume of charge, thus establishing alternatively a low effective compression ratio of the engine. The volume of charge captured at the closing of valve 16, alternatively ranges between 80% and zero % of the displaceable volume of the cylinder, ideally producing effective compression ratios between 9:1 and 1:1.
   In combustion system (b), alternatively after cooling engine components with recessed air, the charge volume captured by closing valve 16 during the compression stroke is non-selective and is composed of the displaceable volume of the cylinder not yet displaced at the closing of the valve 16 and ranges between 80% and zero % of the displaceable volume, with ideal effective compression ratios of between 9:1 and 1:1, the latter being when zero percent of charge is captured and the volume of charge trapped is the approximate volume of charge contained in the combustion chamber.
3. (a) During the charge adjustment/compression stroke of piston 22, at the point the intake valve 16 is closed, in 2(a) and 2(b) operation, alternatively further compression of charge into the combustion chamber occurs alternatively producing a low effective compression ratio. This restrains the temperature rise during the final part of the compression stroke. In this combustion system (a), the intake valve(s) 16 is alternatively closed in the compression stroke at between the time 80% and zero % of the displaceable volume of the cylinder has been recessed and used for engine component cooling.
4. (a) In combustion systems (a) and (b) with intake valve 16 closed, further compression of the captured charge takes place with fuel being injected at any, or many points at any time after intake valve 16 closed and alternatively during the first part of combustion process, then after piston 22 reaches about 20-5° BTDC, the charge is alternatively ignited by spark or glow plug, combustion begins and produces a large expansion of the gases against the piston 22 producing great energy in mode 2(a) and 2(b) which drives the power (3^{rd}) stroke followed by the opening of the exhaust near piston BDC followed by the scavenging (4^{th}) stroke, completing one power cycle for combustion systems (a) and (b).
   (5) In combustion system (c) with charge air pressure extremely high—to as much as 500 psi (34 atmos), the intake valve(s) 16 are alternatively held open non-selectively, through the intake and compression strokes to within about 20-5° BTDC and then closed, capturing little, or only approximately that volume contained in the combustion chamber. No further compression of the captured charge takes place and alternatively with piston 22 being between 20-5° BTDC or earlier, fuel is injected by injector 24 (see FIG. 4), (at or after valve 16 closure), the charge is alternatively ignited by spark or compression somewhere between 20 and 5° BTDC, and combustion occurs producing the power (3^{rd}) stroke followed by the opening of the exhaust valve near BDC for the scavenging (4^{th}) stroke, thus completing one power cycle for combustion system (c) of the engine of FIG. 1 of this invention.

### Detailed Description of Operation of the Engine 100¹ of FIG. 1

### Combustion System (a)

During the intake (1^{st}) stroke of the piston 22, the intake valve 16 is opened and held open through the intake stroke filling cylinder 7 and past bottom dead center of piston position, and through part of the compression (2^{nd}) stroke for a significant distance, alternatively for 20% to perhaps as much as 100% of the compression stroke, pumping a portion of the air or air-REG charge of the cylinder of cool roiling air back against combustion chamber, against the concave-shaped outer faces of the heads of exhaust valve 17e and valve 16 and against their ports with a portion of the charge now containing absorbed heat and being recessed going back through valve 16 and into conduit 15 and through intercooler 13C and 14C and then back into intake manifold 13 and 14, the intake valve 16 having alternatively closed at a predetermined point to capture a specific volume of charge, before or at the time piston reaches 20-5° BTDC, to be further compressed into the combustion chamber to establish a low effective compression ratio in the combustion chamber of the engine. At any time or point in the piston 22 stroke after closing of inlet/outlet valve 16, fuel is injected through fuel injector 24, shown in FIG. 4, directly into the combustion chamber 7x and for diesel fuel, alternatively it is injected at, during and after valve 16 closure. The charge is alternatively ignited at approximately 20-5° BTDC position of piston 22 by spark or glow plug. The explosion of the charge drives piston 22 in the expansion power stroke followed by opening exhaust valve at near BDC followed by the exhaust stroke, thus completing one working cycle of the engine of FIG. 1.

### Combustion System (b)

In combustion system (b) the charge volume captured by closing the inlet/outlet valve 16, during the engine-cooling-compression stroke is non-selective always capturing a constant volume of charge at any level of cylinder contents between 80% and zero % of the displaceable volume of charge in cylinder 7x, preferably capturing a charge with an effective compression ratio of between 9:1 and 1:1, the latter when valve 16 closes near TDC of piston 22. The charge is fuel injected by injector 24 same as for combustion system (a) and the charge is ignited by spark or glow plug 25 alternatively at between 20-5° BTDC.

For diesel operation, after closure of valve 16, fuel is injected into the charge by one or several injections during late piston travel and with piston 22 at 20-5° BTDC, with the main fuel injection(s) being at 10° BTDC with one or more injections being directly onto hot glow plug, igniting the charge and with several fuel injections following start of combustion. In any of the engine designs, for diesel the valve 16 closes at a point that the engine is producing an effective compression of 9:1 to 8:1, the ignition being assisted by a glow plug.

In combustion systems 2(a) and 2(b), alternatively at any point deemed desirable in the pistons second stroke, closure of the intake valve 16 or outlet valves 16o or V15, occurs and the charge is alternatively further compressed, fuel is injected by injector 24 in FIG. 4, FIG. 4A and FIG. 4B in one or several injections, which alternatively are also done early in the combustion, the air-fuel charge is ignited by spark or compression at between 20° and 5° BTDC, as stated and the gases expand against the piston for the power (3^{rd}) stroke. Near bottom dead center at the opportune time, exhaust valve(s) 17e FIG. 4, FIG. 4A, FIG. 4B open and piston 22 rises in the scavenging 4^{th} stroke, efficiently scavenging the cylinder by positive displacement, after which exhaust valve(s) 17e closes. There is no appreciable valve overlap or under-lap for scavenging.

This completes one cycle of the 4-stroke engine for combustion systems (a) and combustion system (b) in the engine of FIG. 1.

For any engine design of this invention, FIG. 1, 2, 4, 4A, 4B, 6 or 7, when greater power is needed in combustion system (a) inlet valve is closed earlier to capture, compress and fire a heavier combustion charge and in (a) and (b) combustion systems the charge-air density and weight is alternatively further increased by increasing the speed of the compressors or by cutting in other compressors for additional stages of compression and power level is further controlled by varying fuel output. All can be done by the ECM-27 signaling other stages of compression and cooling to begin or alternatively to increase compressor speed while increasing fuel input and density, all in order to further condense the charge and/or fuel and lessen the increase in the charge temperature. This increases the mean effective cylinder pressure during combustion for high torque and power.

The heavier the weight of the air charge and the denser the charge, the later in the compression stroke intake valve 16 or in engine of FIG. 2, FIG. 4, FIGS. 4A and 4B outlet valves 16o or V15 can be closed to establish a low effective compression ratio and retain power, and the less heat and pressure is developed during final compression within the cylinder. In this 4-stroke engine, the intake charge alternatively is boosted in pressure by from ⅓ atmospheres to as much as 34 atmospheres and the effective compression ratio ideally lies between 9:1 and 1:1 and even spark-ignited there would be no problem with detonation. For ignition of diesel fuel, the effective compression ratio of 9:1 to 8:1 is preferred with ignition by glow plug and alternatively with the air or air-REG charge being heated in starting engine only.

### The Engine 100² of FIG. 2

Referring now to FIG. 2, there is shown a six cylinder reciprocating ICE 100² in which all of the cylinders 7a-7f (only two 7a, 7f of which are shown in a schematic drawing) and associated pistons 22a-22f operate in a 4-stroke cycle and all power cylinders are used for producing power to a common crankshaft 20 via connecting rods 19a-19f, respectively which cylinders operate in a 4-stroke cycle. A primary ancillary turbo-compressor 1, (which system is alternatively in number from 1 to 4, in-series turbo-compressors and cooler stages), is used, selectively, to boost the intake air pressure to manifolds 13 and 14. Valves 3, 4, 5 and 6 and intercoolers 10, 11, 12, 13C and 14C are used in the preferred embodiments, to control air charge density, weight, temperature, turbulence and pressure and to provide cooling for internal engine components. The intake valves 16i and charge recess outlet valve 16o shown in FIG. 4, FIG. 4B, FIG. 6 and FIG. 7 and outlet valve V15 of FIG. 4A are timed to and/or adjusted to control the effective compression ratio of the engine 100² and to cool internal engine components between each firing in the combustion chamber. The combustion chambers and cylinders are sized to establish the expansion ratio of the engine.

The engine 100² shown in FIG. 2 is characterized by a more extensive expansion process, a low effective compression ratio and the capability of producing a combustion charge varying in weight from normal-to-heavier-than-normal, and capable of selectively providing a mean effective cylinder pressure higher than can the conventional arrangement of normal engines but having similar or lower maximum cylinder temperatures and pressure in comparison to conventional engines. An engine control module (ECM-27) and variable valves 3, 4, 5 and 6 on conduits as shown, provide a system for controlling the charge density, turbulence, pressure, temperature and the mean and peak pressure within the cylinder which allows greater fuel economy, production of greater torque and power at low RPM, with low polluting emissions for both spark and compression-ignited engines. In the various embodiments a variable valve timing system is alternatively used, and with appropriate sensors and servo systems and a control system such as an engine control module (ECM-27), alternatively controls the time of opening, and the time of closing of the intake valve(s) 16i and outlet valve, 16o and 2-way valve V15 in order to vary the effective compression ratio of the engine and to further provide an improved management of conditions in the combustion chambers of cylinders 7a-7f of the engine 100² and to provide cross-flow heads, in all systems except in engines of FIG. 1 and FIG. 4A, but with all designs promoting cooling of cylinder, cylinder head, combustion chamber, intake and outlet valves between each firing, all to provide lower emissions and to allow for greater torque and for a flatter torque curve and higher power, and with low levels of fuel consumption, polluting emissions and noxious odor. Additional embodiments, shown in FIG. 6 and FIG. 7 and described for the engine of FIG. 2, provide precombustion and two-stage combustion systems for spark ignited and compression-ignited systems and also in FIG. 5 provides in any reciprocating engine for increased combustion burning time and greatly increased torque with the degree of performance in both of the latter improvements being variable and are varied.

### Brief Description of Operation of the Engine 100² of FIG. 2

2(a) The engine 100² of this invention shown in FIG. 2 is a high efficiency engine that attains both increased power and torque with low fuel consumption and low polluting emissions. The new working cycle is an external compression type internal combustion working cycle. In this cycle the intake air or air-REG mixture is compressed selectively by at least one primary compressor 1 (which systems provide from one to four turbo-compressions with each stage of compression being by air or fluid cooled after compression. In the preferred embodiment and design, in combustion systems (a) and (b), the charge or charge mix is further compressed in-cylinder.

In combustion system (a), the effective compression ratio is selectively variable and is varied.

In an alternative design, combustion system (b), the excess charge recession, charge trapping and further compression and igniting of charge is performed the same as in combustion system (a) with the exception that the effective compression ratio is non-selective. The temperature rise during compression can be suppressed, by use of air coolers 10, 11, 12, 13C and 14C, which cool the intake air or air-REG charge and further provides cooling of components of the engine head and valves and by a lower effective compression and alternatively in combustion system (c) by having no further compression in-cylinder.

### Cross-Flow Cooling

The components of the engine of FIG. 2 are the same as those of FIG. 1 engine except for the addition one outlet valve 16o and a different style of intake valve 16i and the addition of an alternative auxiliary conduit and a “Cross-Flow” route for cooling engine internal components and recessed charge air or air-REG mixture for each cylinder of the engine.

One suggested, preferred method of operation of the new-cycle engine 100² is thus:
1. Intake air or air-REG mixture that has been compressed by at least one ancillary compressor and has had its temperature and pressure adjusted by bypass systems and charge-air coolers, is drawn from intake manifold 13 or 14 into the power cylinder 7 by the intake stroke of piston 22, the cool air charge entering cylinder 7 by way of conduit 16ai and intake valve 16i.
2. (a) The intake valve 16i or V15 (which can be single or multiple) is opened alternatively at piston TDC after the exhaust stroke is complete, until the piston 22 has allowed filling of cylinder 7 and then closes at BDC. At that point, outlet valve 16o opens or two-way valve V16 reverses the direction of flow and piston 22 is now reversed and with great speed, pumps all of the cool fresh air charge up roiling, against combustion chamber, intake valve, exhaust valve, outlet valve and port, the charge absorbing the heat from the last ignition and firing, then during the compression stroke a portion of the charge, alternatively from 20-100% of the displaceable volume of the cylinder, now warmed, is recessed and expelled passing through outlet valve 16o or (V15 before its closure), conduit 15ao, intercooler 14C or 13C and then back into the intake manifold 13 or 14. Then at the specified point in combustion system (a) and (b), outlet valve 16o or V15 is closed interrupting the flow of recessed charge to intercooler 13C or 14C and back to intake manifold 32 and thus trapping a specific volume of charge to alternatively be further compressed, and with the closing time in combustion system (a) being selectively variable, establishing the effective compression ratio of the engine for the duty cycle of the engine for that particular time. As the charge is now compressed toward and into the combustion chamber of cylinder 7, fuel is injected alternatively at any time at, or after valve 16o or V15 closure and at one or many points until piston is at between 20-5° BTDC and fuel having been injected by injector 24, FIG. 4, after valve 16o or V15 closing, the charge is alternatively ignited by spark or glow plug 25, FIG. 4, at 20-5° BTDC of piston 22. For diesel fuel, the fuel is injected in light sprays late in the compression process with the main spray occurring directly on the glow plug 25 with ignition occurring alternatively after piston 22 is 20-5° BTDC, with light sprays after combustion begins, the charge having been ignited by preferred compression ratio of 9:1 to 8:1 with aid of fuel being injected directly onto glow plug 25, FIG. 4.
   The volume of charge captured alternatively ranges between 80% and zero % of the displaceable volume of the cylinder, ideally producing an effective compression ratio of between 9:1 and 1:1 depending on the fuel used and the charge density. (At such a time that outlet valve 16o closes after practically all of the displaceable charge in cylinder 7x has been displaced, only the charge in the combustion chamber, with no additional compression, is fueled early at or after outlet valve closure and ignited between 20-5° BTDC of piston TDC producing an effective compression ratio of approximately 1:1.) The exploding charge drives piston 22 into the power stroke followed by the opening of exhaust valve near BDC, followed by the exhaust stroke.
2. (b) Alternatively in combustion system (b), the charge volume captured by closure of valve 16o, is non-selective and is composed of any percentage of the displaceable volume of the cylinder 7x not yet displaced at the closing of valve 16o which volume ranges between 80% and zero % of the displaceable volume of the cylinder with the ideal effective compression ratio being between 9:1 and 1:1, the latter effective compression ratio being when little or no charge was captured outside of the combustion chamber 5A, FIG. 4. Fuel is injected alternatively at or after valve 16o closing and injections of fuel by injector 24, FIG. 4, alternatively continues during the last part of compression stroke and the charge is ignited by spark producing the power and exhaust strokes. Diesel ignition is alternatively by fuel injection beginning early after outlet valve 16o or V15 closure with the main injection being directly onto the glow plug 25, FIG. 4, the ignition aided alternatively by a compression ratio of 9:1 to 8:1, with ignition beginning at piston position of between 20-5° BTDC, producing the power stroke, followed by the scavenging stroke, completing one power cycle of the engine of FIG. 2 operating in combustion system mode 2(a) and 2(b).
3. (a) During the compression stroke of piston 22, at the point the outlet valve 16o closed, in 2 (a) operation, further compression of the captured charge occurs, producing a low “effective” compression ratio. This reduces the temperature rise during the “effective” portion of the compression stroke. In this combustion system (a) a very low effective compression ratio is preferred. The outlet valve 16o is alternatively closed at a point which captures between 80% and zero % of the clearance volume of the cylinder 22, making possible to produce “effective” compression ratios of 18:1 to 1:1, in an engine with an expansion ratio of 18:1 with a preferred effective compression ratio of 9:1 to 1:1.
4. For combustion system (a) further compression occurs on any captured volume of charge, as fuel is injected by injector 24, FIG. 4, at any or many points between valve 16o closure and charge ignition, compressing the charge into the combustion chamber of cylinder 7 and alternatively at piston 22 being at a position of 20-5° BTDC, the charge is ignited by electric spark or glow plug and combustion begins and produces a large expansion of the gases against piston 22 producing great energy in combustion system (a) and (b). The power stroke occurs followed by the scavenging stroke, thus completing one power cycle for combustion system (a) and (b) in the engine of FIG. 2 of this invention. For compression ignition, fuel is injected by injector in light sprays late in the compression with a main fuel spray happening near piston TDC, spraying directly onto the glow plug with same additional fuel sprayed early in the combustion process.
   In combustion system (c) with charge air pressure from atmospheric pressure to as much as 500 psi or (34 atmos.) the outlet valve 16o is alternatively held open through the intake and compression (engine-cooling) stroke of piston 22 to within about 20-5° BTDC and then closed, capturing approximately that volume of charge of air or air-REG contained in the combustion chamber. No further compression of the captured charge takes place and while piston 22 is near or at 20-5° BTDC, fuel is injected at one, or several points just prior to, at, or after closure of outlet valve 16o, the charge is alternatively ignited at between 20-5° BTDC and combustion takes place, followed by the power (3^{rd}, stroke and the scavenging (4^{th}) stroke, thus completing one power cycle in combustion system (c) of the engine of FIG. 2 of this invention.

### Detailed Description of Operation of the engine 100² of FIG. 2

After each charge ignition, among other things, the following takes place, during the next intake (1^{st}) stroke of the piston 22, the intake valve 16i is opened and held open through the intake stroke where cylinder 7 is filled with cool air or air-REG charge and at piston 22 at BDC, inlet valve 16i closes, outlet valve 16o opens, piston 22 reversing itself and with great speed goes through part of the compression (2^{nd}) stroke for a significant distance, alternatively from 20% to as much as 100% of the compression stroke, pumping a portion of the cool high pressure charge-air up against the alternatively concave bottom of exhaust valve 17, bathing all of the combustion chamber, piston crown, inlet 16i and outlet valve 16o and their ports, providing cooling of these components by absorbing their heat and then alternatively outlet valve 16o is closed at a specified point, sealing cylinder 7 and capturing the volume of charge needed that after further compression and with fueling and igniting, to provide proper power to the engine and to establish alternatively a low effective compression ratio. Before closure of outlet valve 16o recessed excess charge air was expelled out of cylinder 7, then sent through conduit 15ao, intercooler 13C or 14C, FIG. 2 or FIG. 4 and into intake manifold 13 or 14, which manifolds receive air or air-REG from conduit 113 or 114. In combustion system (a) outlet valve 16o is closed alternatively at a point which captures from about 80% to zero % of the displaceable volume of cylinder 7 and at the point of outlet valve 16o closure, further compression takes place on any volume of charge captured in cylinder 7x which is outside of the combustion chamber 5A, FIG. 4. For a spark ignition, fuel is injected by injector 24, FIG. 4, at, or at any time after closing of outlet valve 16o and with injections alternatively being one or several at or after closure of valve 16o, which injections alternatively continue as necessary until combustion begins. Then at piston position of approximately between 20 and 5° BTDC the air-fuel or air-fuel-REG charge is ignited by spark plug and the exploding gases expand against the piston for the power (3^{rd}) stroke. Near bottom dead center at the opportune time exhaust valve(s) 17e opens and piston 22 does a turnaround and rises in the scavenging (4^{th}) stroke, efficiently scavenging the cylinder by positive displacement, after which the exhaust valve(s) closes. (For compression ignition fuel is ignited, after closure of valve 160, near the end of the compression stroke in one or several fine sprays, with a main spray occurring directly onto the glow plug, igniting the charge with alternatively some fuel being injected early in the combustion process.

This completes one working cycle of the 4-stroke engine in combustion system (a) and (b) of engine 100² of FIG. 2, with engine of FIG. 2 being in conjunction with FIG. 4.

The heavier the weight of the air charge and the denser the charge, the later the intake valve can be closed to establish a low effective compression ratio and retain power, and the less heat and pressure is developed during the “effective” compression process any compression in the cylinder. In this 4-stroke engine the intake charge can be boosted in pressure by as much as one-third atmosphere to as much as 34 atmospheres and the engine's effective compression ratio range is ideally and alternatively 9:1 to 1:1. Diesel ignition of any gaseous or liquid fuel is feasible while using the preferred effective compression ratio of 9:1 to 8:1, the ignition aided by a glow plug and alternatively heating of the charge air or air-REG mix, during engine starting process.

Referring now to FIG. 3, there is shown a schematic drawing of cylinder with cross-flow cooling and with engine head components shown also in the ICE components of FIG. 4 and also useful in the engines of FIG. 2, FIG. 6 and FIG. 7 being also useful and used in conjunction with the components shown and described in FIG. 4 and in any current technology engine, representing a third alternate embodiment of the apparatus of the present invention shown in FIG. 2, from which a third method of operation can be performed and will be described. Among its other components, this embodiment is seen as having a power cylinder 7x, representing any power cylinder of the engines of FIG. 2, FIG. 4, FIG. 6 and FIG. 7 the principals also expressed in other engine designs of this invention, e.g. FIG. 4B in which cool air enters an engine through one port, cools engine components, exits a second port or route, goes through a cooler or coolers and is stored, after leaving enough charge air or air-REG captured in the compression cylinder to be further compressed, fueled and ignited and/or remaining in combustion chamber when fueled and ignited, to power the engine after fueling and igniting and in which likewise the cross-section of the head of cylinder 7 shows that alternatively the intake valve 16i which opens on piston intake stroke and closes at piston BDC and the head of recessed-charge outlet valve 16o which opens at the end of the intake stroke and closes alternatively at a specified point on the compression stroke, after recessing any excess charge which has cooled the engine components, and alternatively has now trapped, by that closing, then further compressed, fueled and ignited the combustion charge whose density and volume is that needed which volume is alternatively and generally somewhere between 80% and zero % of cylinder 7x displaceable charge volume, which valves 16i, 17e and 16o are so arranged that exhaust valve 17e is situated between the charge inlet valve 16i and engine-cooling, charge-recession, charge-volume-adjusting/compression process outlet valve 16o, the valves all alternatively having concave shaped or finned heads in order to impart their heat to the recessed air charge as it is recessed and before going through outlet valve 16o, and through intercooler 4C en-route back to manifolds 13, for further use.

Referring now to FIG. 4, there is shown more clearly a part sectional view through several components of the ICE of FIG. 2 (shown for use in FIG. 2 engine and also described in conjunction with embodiments of FIG. 4B, FIG. 6 and FIG. 7 and illustrating the same principle in other engine designs of this invention, whereby the entire charge, by conduit 16ai, enters at one port and valve 16i and is pumped around in engine during the compression stroke and cools internal engine components then with a very significant percentage of the cooling air or air-REG charge now heated flowing out a different conduit 15ao and valve 16o and port during the said compression stroke and then through intercooler 4C in order to cool engine components and representing again and better describes the third alternate embodiment of the apparatus of the present invention from which the third method of operation can be performed and which is described here in greater detail. This embodiment is seen as receiving charge air, or air-REG mix from conduit 114 coming from conduit 114 of engine of FIG. 2 and in which embodiment shown in FIG. 4 as having an exhaust valve 17e which exhaust valve from cylinder 7x, in engine head 100² is also representative of exhaust valve of FIG. 2, FIG. 4B, FIG. 6 and FIG. 7, and any exhaust valve of this invented ICE of FIG. 2, FIG. 4B, FIG. 6 and FIG. 7, the valve 17e alternatively having a valve head arranged with a concave faced or finned head, whereby charge air from manifold 13 travels through conduit 16ai, enters intake valve 16i, fills cylinder 7x on intake stroke of piston 22 where upon inlet valve 16i closes at piston 22 at BDC, whereupon excess charge outlet valve 16o opens and now on second stroke with intake valve 16i, now closed, a large portion of the roiling cool charge, given impetus by piston 22, impinges against engine head and other parts of the engine including exhaust valve 17e and with one valve on each side of the exhaust valve, which are intake valves 16i and outlet valve 16o, (both of which alternatively also have heads that are concave shaped or are finned on the in-cylinder face) and the rest of the combustion chamber proper, with much of the cooling charge which has now absorbed the heat from the last firing and combustion and of which much of the warmed charge is now recessed through outlet valve 16o leaving any needed portion of the charge trapped at the closure of outlet valve 16o, to be further compressed, fueled and ignited, providing power to the engine. The recessed portion of the charge has now gone out valve 16o to conduit 15ao, through intercooler 4C to return the re-cooled charge back to intake manifold 13, which manifold receives much charge recessed in combustion systems (a) and (b).

In combustion system (c), the entire displaceable volume of cylinder 7x being recessed after cooling internal engine components has left only the volume of charge contained and captured in the combustion chamber 5A, FIG. 4, FIG. 4B, FIG. 6 and FIG. 7 to fuel and ignite to power the engine, and the excess charge, now recessed and having passed through intercooler 4C, is channeled back to intake manifold 13.

Referring now to FIG. 4A, there is shown more clearly a part sectional view through several components of the ICE of FIG. 2 (shown for use in FIG. 2 engine and also described in conjunction with embodiments of FIG. 4, FIG. 4B, FIG. 6 and FIG. 7) and illustrating the same principle in other engine designs of this invention, whereby the entire air or air-REG charge enters through conduit 16ai at one valve V15 and port and is pumped around in engine and cools internal engine components then with a very significant percentage of the cooling air or air-REG charge flowing out the same port, through the same valve V15, which is a two-way valve, which now directs the exiting charge through conduit 15ao and through intercooler 4C in order to cool engine components and representing the fourth alternate embodiment of the apparatus of the present invention from which the fourth method of operation can be performed and which is described here. This embodiment is seen as receiving charge air, or air-REG mix from conduit 114 coming from conduit 114 of engine of FIG. 2 and in which embodiment shown in FIG. 4A as having an exhaust valve 17e which exhaust valve from cylinder 7x, in engine head 100² is also representative of exhaust valve of FIG. 2, FIG. 4B, FIG. 6 and FIG. 7, and any exhaust valve of this invented ICE of FIG. 2, FIG. 4, FIG. 4B, FIG. 6 and FIG. 7, the valve 17e alternatively having a valve head arranged with a concave faced or finned head, whereby charge air from manifold 13 travels through conduit 16ai, enters two-way inlet/outlet valve V15, fills cylinder 7x on intake stroke of piston 22 whereupon the two-way inlet/outlet valve V15 closes the valve port to intake conduit 16ai at piston 22 at BDC, whereupon excess charge outlet port of valve V15 opens and now on second stroke with two-way intake/outlet port to conduit 16ai now closed, a large portion of the roiling cool charge, given impetus by piston 22, impinges against engine head and other parts of the engine including exhaust valve 17e and inlet/outlet valve V15 and the rest of the combustion chamber proper, with much of the cooling charge which has now absorbed the heat from the last firing and combustion and of which much of the warmed charge is now recessed through valve V15 outlet port leading to outlet conduit 15ao which then closes at a specified point of piston 22 alternatively leaving a significant portion of the charge trapped at the closure of outlet port of valve V15 to be compressed, fueled and ignited, providing power to the engine. The recessed portion of the charge has now gone out through outlet port of valve V15 to conduit 15ao, through intercooler 4C to return the re-cooled charge back to intake manifold 13, which manifold receives much charge recessed in combustion systems (a) and (b).

In combustion system (c), the entire displaceable volume of cylinder 7x being recessed after cooling internal engine components has left only the volume of charge contained and captured in the combustion chamber 5A, FIG. 4A to fuel and ignite to power the engine, and the excess charge, now recessed and having passed through intercooler 4C, is channeled back to intake manifold 13.

Referring now to FIG. 4Ai, there is shown a cross-section of the inlet-outlet valve of FIG. 4A, showing means of inducting charge into cylinder 7x and then closing the incoming charge off from exit conduit 16ai and allowing a portion or all of the inducted charge to reverse flow into outlet conduit 15ao by rotating valve Core A 90 degrees clockwise at piston BDC.

Referring now to FIG. 4Ao, there is shown a cross section of two-way valve 15A showing how at piston BDC the incoming charge is stopped and diverted out through valve V15 and through conduit 15ao during a compression stroke. It also shows that rotating valve V15 Core A another 45 degrees clockwise, captures any volume of desired charge in cylinder 7x.

Referring now to FIG. 4B, there is shown a part sectional view through alternate components not shown in the ICE of FIG. 4, with FIG. 4B herewith representing a fifth alternate embodiment of the apparatus of the present invention (also useful in any reciprocating engine whether present technology or new) from which drawing arises and better illustrates the fifth method of operation that can be performed and will be described. This embodiment is seen with all of the other components shown in FIG. 4, which components are an engine head and block 100², a cylinder 7x, piston 22, now piston 22b, an exhaust valve 17e with exhaust conduit 18a, which exhaust valve 17e is representative of any exhaust valve of this invented ICE of FIG. 1, FIG. 2, FIG. 4, FIG. 4A, FIG. 6, FIG. 7 and other designs of this invention, the valve 17e alternatively having its valve head situated between charge inlet valve 16i and recessed-charge outlet valve 16o, said valve heads alternatively arranged with concave shaped or finned face of the heads whereby between each firing-power and exhaust stroke, cool charge air enters intake valve 16i, fills cylinder 7x on intake stroke with intake valve 16i closing and outlet valve 16o opening at piston BDC and on the beginning of the compression stroke, with inlet valve 16i closed, the power piston 22 pumps the cool recessed charge received on the intake stroke up against the engine head and into the hot concave-shaped or finned heads of exhaust valve 17e and the adjacent valves, absorbing much of the heat into the charge air and now outlet valve 16o recesses and expels all of the charge not needed for power through outlet valve 16o, and then closes valve 16o capturing and further compressing any specified volume of charge required that after further compression, if needed, and after fueling and igniting to power the engine, the recessed portion of charge-air or air-REG having gone through conduit 15ao, intercooler 4C and returned the now re-cooled charge air to intake manifold 13 for further use.

The fifth alternate embodiment of the engine of FIG. 1, FIG. 2, FIG. 4, FIG. 4A, FIG. 6 and FIG. 7 of this invention as illustrated in FIG. 4B illustrates both means and method of increasing power, torque, fuel economy and engine durability while significantly reducing polluting emissions by increasing the total reactive surface area of piston head and the opposing engine head by constructing the piston as having a decided peak beginning at the outer periphery of the piston crown above the piston rings, the piston 22b forming a peaked head so fashioned that the peak rises to a significant height with the angle of slope from the piston outer rim being a constant angle to near the top of the piston peak. The adjacent surface of the engine head combustion chamber recedes and maintains the same constant slope. The combustion chamber volume being designed and situated to provide the required volume of charge needed to power the engine.

### OPERATION

The method and results of fashioning piston 22 of current technology engines and the piston 22b of the engines of this particular co-invention with a steep peaked crown and a similarly recessed engine head is:
1. (a) in operation piston 22 on the charge intake stroke of a normal engine, Otto or diesel, pulls in air or air-REG mixture charge, piston going to bottom dead center (BDC), reverses the direction of piston and compresses the charge above a flat or usually so, piston compressing the charge into the combustion chamber, fuel is added if not present, the charge is ignited, near piston TDC position, the explosion of the gaseous charge creating great pressure on all exposed areas of piston and engine head, driving piston 22 into a power stroke.
   (b) in the engine of this particular invention, as specified for FIG. 2, FIG. 4, FIG. 4A and FIG. 4B, air is received through intake valve 16i during the intake stroke and at piston BDC, the intake valve 16i closes and outlet valve 16o opens as piston 22b reverses direction and pumps a portion of the cool charge over engine internal components and out of the combustion chamber by way of outlet valve 16o and through intercooler 4C and into manifold 13, then at a specified point in the compression stroke, outlet valve 16o closes capturing a specified volume of charge that when alternatively further compressed, is fueled and as specified for engine of FIG. 2 and FIG. 4, with piston 22b at near top dead center, the charge is ignited by spark or compression, the fuel or fuel-air-REG mix exploding creating great pressure and force against all exposed surface area of piston 22b crown and opposing engine head inner surface.
2. In system 1(b), certain advantages take place over current engine 1(a).
3. Advantages: (i) Firstly, the exposed surface area of piston 22b and engine head 22C is much greater than normal therefore, there is a greater total area exposed which with the same pressure of a current engine creates a greater total force on the piston 22b adding impetus to its movement. (ii) Secondly, the force of the explosion comes from all sides, the piston 22b being at or near TDC and having little or no motion, receives most of the initial force laterally against the sloped peak. This horizontal or lateral force acting against steeply sloped piston crown quickly converting to kinetic energy on the piston that is not moving quickly, converting the lateral and vertical explosion force into linear kinetic energy (motion), giving great impetus to acceleration of piston 22b in engine system 1(b).
   (1) Greater surface areas being exposed, much greater power is produced in piston 22b.
   (2) The lateral force against the greater total area of the piston converts much of the force into linear kinetic motion, with the combined force imparting more power to the piston than would an equal force conveyed to a current technology piston of the same diameter, having a flat or slightly concave surface (making the piston greatly concave will produce a similar advantage).

In this design it is expected that the engine alternatively operated with a normal or even a lower than normal compression ratio and/or operated with a lower or normal effective compression ratio will develop lower peak temperatures and pressures and will produce greater power, torque, fuel-economy and engine durability, while producing lower polluting emissions than do current technology engines and is very useful for increasing power in HCCI operated or in current technology engines.

The engine of FIG. 4B is fitted with the same components as that of FIG. 2, FIG. 4 or that of FIG. 4A and operates the same as specified for engines of FIG. 2, FIG. 4 and FIG. 4B, or FIG. 4A, FIG. 6 and FIG. 7.

Referring now to FIG. 5, there is shown a part sectional view through other alternative components of the ICE shown in FIG. 1, FIG. 2, FIG. 4, FIG. 4A, FIG. 4B, FIG. 6 and FIG. 7 with the principles expressed and illustrated in conjunction with the engine of FIG. 4 but adaptable to any other engines of this invention and which components and principles are usable and valuable in any current technology reciprocating engine, the technology representing a fifth alternate embodiment of the apparatus of the present invention from which the fifth method of operation can be performed and which is described herein. This embodiment is shown in a schematic transverse sectional view as having a crankshaft 48, two connecting rods 19′ and 19″ and a beam 39 having two rotating pins 39′ and 39″ and a “fulcrum” pivot pin 42″ showing a means of (a) providing extra burn time and (b) means for providing much greater torque, with the degrees of improvements in burn time and in torque improvement both being variable and are varied in the degree of performance improvement desired in the engines of this invention or any current technology, conventional 2-stroke or 4-stroke engine.

### Clean-Burn

(a) This layout for any engine provides for double the piston 22 turn-around time of a normal engine during the critical burn period. This is because piston 22 top dead center (TDC) occurs at bottom dead center (BDC) of the crank 48. At this point, crankpin motion around piston 22 top-dead-center is subtracted from the straightening movement of the connecting rod 19′, instead of being added to it as in conventional engines. Reversing the usual action slows piston travel around this point, resulting in more burn time for more complete combustion along with allowing the exploding gases more time to build peak pressure before piston 22 moves and both features further reduce polluting emissions.

The extra and variable burn time provided by the design of FIG. 5, as illustrated on engine of FIG. 4, is important in the engines of this invention and to any current technology reciprocating Otto or Diesel cycle engine.

(b) Shown also in FIG. 5 is a sixth alternate embodiment useful in the ICE of FIG. 1, FIG. 2, FIG. 4, FIG. 4B, FIG. 6 and FIG. 7 which embodiments and its principles are also usable and valuable in any current technology reciprocating engine representing again a sixth alternate embodiment of the apparatus of the present invention from which the sixth method of operation can be performed and which will be described showing (b) a means of greatly increasing engine torque, which system alternatively provides also a controllably variable degree of torque, and is useful in the engines of this invention and also useful to any reciprocating ICE.

Alternatively in FIG. 5, the fulcrum pivot pin 42″, (pivot point) of connector link 39 with its rotating connector pins 39′ and 39″, between connecting rod 19″ and connecting rod 19′ is seen arranged closer to rod 19″ than it is to connecting rod 19′ as pictured, to greatly increase the torque of the engine. The fulcrum pivot pin 42″ position on link 39 is alternatively slideably variable and is varied in the design of the engine to provide any degree of torque desired.

In the operation of the engine constructed and arranged with the additional burning time and/or increased torque, the degrees of increase and decrease of both are variable and are varied, and these features are very advantageously used in conjunction with the other engines of this present invention providing high charge density, low effective compression ratios with a mean effective pressure higher than conventional engines and alternatively with more and variable combustion time and/or alternatively much greater and variable torque than any other engines, while producing even less polluting emissions. Refer to FIG. 5 and note in addition to being able to produce extremely high torque and double the normal burn time, the degree of burn-time and/or torque alternatively is varied at will by arranging fulcrum pivot point pin 42″ being placed in bearing 43 and both arranged slideably in connector arm 39, with connector arm 39 being linked to connecting rod 19′ which is attached to arm 39 by rotating pin 39′ and to connector rod 19″ by rotating pin 39″ and with bearing 43 surrounding fulcrum pin 42″ becoming attached rotatably on upper end to the center of truck 2, which truck 2, being attached to and surrounding pivot pin 42″ forms a “truck” 2 riding in a slot 1 in arm 39, the “truck” 2 being fastened in link or beam 39 with a sturdy servo system 18 linked to the fulcrum 42″ truck mechanism 2, the servo system 18 being controlled by threaded bar 10, rotating bi-directional by servo motor 7, as bar 10, penetrating a female threaded, mated opening 5 in adjustment arm 4, the adjustment arm 4, being attached rotatably on upper end to the center of truck 2, which truck 2, being attached to and surrounding pivot pin 42″, slidably traveling in slot 1, to and fro as bar 10 rotates in a clockwise or counter clockwise rotation, the direction of rotation and power for rotating produced by servo motor 18, with the signal and electric power coming from engine control module ECM-27. The adjustment arm 4 being firmly attached at the lower (anchored end) to attachment plate 12 to the engine block 13 by pivoting bolt 6 and with signal and power coming through electric lines 11, from ECM-27 causes the movable end of arm 4 to, at its movable end to swing back and forth as threaded rod 10 rotates within a threaded rotatable section of arm 4 in one direction or the other carrying the truck 2 and pivot pin 42, toward or away from the prior fulcrum point which moves fulcrum pivot point 42″ closer to connector rod 19″ and away from connector rod 19′, as the fulcrum 42″ of lever bar 39 moves toward connector rod 19″, the torque of the engine transmitted to the drive shaft 49 is increased. The reverse is true when the arm 4 is moved by reverse rotation by servomotor 18. The length of burn time also increases and decreases as the fulcrum “pivot pin” is moved by servo system 18 toward or away from connector rod 19″. An expanding joint 3 in arm 4 allows extension and contraction of the arm-4 length to accommodate the increase and decrease of the distance between pivot pin 42″ and anchor pin 6 as truck 2 slides to and fro in slot 1 in beam 39.

This is done all in order to move fulcrum pivot pin 42″ truck 2 toward or away from connecting rod 19″ alternatively performed manually or by a servo system 18 activated by engine control module (ECM-27), all in conjunction with the engines of FIG. 1, FIG. 2, FIG. 4, FIG. 4B, FIG. 6 and FIG. 7.

Since the crankshaft 48 in FIG. 5 itself does no more than transmit torque, its main bearings 48′ will be very lightly loaded. As a result little noise will reach the supporting casing. Because of the lever action advantage, the crank can alternatively have as little as half the throw of the piston stroke (depending on the point of the fulcrum pivot pin at the moment), and can be a stubby, cam-like unit with large, closely spaced pins having substantial overlap for strength.

This layout also provides not only greater torque, but also for nearly twice or more the burn time of a conventional engine during the critical burn period, both being variable. The latter is because piston top dead center occurs at bottom dead center (BDC) of the crank and because the fulcrum of beam 39 can be moved at will by the operator.

Alternatively, the torque of the engine is increased by the position of the fulcrum (pivot pin point) 42″ on connector link 39 between connecting rod 19″ and connecting rod 19′, and with pivot pin 42″ being nearer connecting rod 19″ than to connecting rod 19′, this arrangement greatly increases engine torque. The fulcrum pivot pin 42″ position on link 39 is alternatively variable and varied, as described above, in the engines of this invention or in any other reciprocating engine, according to the amount of torque desired.

Referring now to FIG. 6, there is shown a part sectional and schematic view through one alternate component of the ICE shown in FIG. 2, which ICE receives, conditions and presents charge air or air-REG mix in the same manner as illustrated in FIG. 2 and is so specified for engine of FIG. 2 and for the compressed, cooled charge for the combustion chamber proper 38 for ICE of FIG. 6, which coupled with the views shown in FIG. 4, FIG. 4A, FIG. 4B and FIG. 6 and described herein, aptly presents the latter, FIG. 6, representing an eighth embodiment of the apparatus of the present invention from which an eighth method of operation can be performed and which is described for FIG. 6 here. This embodiment is seen among its other components as having a precombustion chamber 38′, a spark plug 37, with a combustion chamber proper 38, a fuel injector 24, fuel inlet line 23, a charge intake valve 16i, a combustion chamber intake port 16pi and a recessed-charge outlet valve 16o, outlet port 16po, fuel inlet conduit 41 with alternative shut-off valve 40, an optional, needle control valve 1″, fuel inlet channel 36, with alternative check valve 1 which valve is alternatively a two-way active valve and outlet ports 4 from said precombustion chamber 38′, a cylinder 7x, a piston 22 and the engine block and head of engine 100² also shown in FIG. 2 and FIG. 4. Arranged with these components are: outlet conduits 15ao going to intercooler 14C which is fitted with water or air inlet port Vi and outlet port Vo and associated inlet and outlet valves Vi′, Vo′, an outlet conduit 15a, leading from intercooler 14C to intake manifold 13 which manifold is connected to inlet conduit 114 coming from conduit 114 of the engine 100² of FIG. 2.

In preferred embodiments of engine of FIG. 6, the apparatus of the present invention provides a reciprocating ICE, when in combination with the engine 100² of FIG. 2 and FIG. 4, which has as shown in FIG. 2 have at least two ancillary compressors 1, 2 for compressing an air charge, intercoolers 10, 11, 13C, 14C, through which the compressed air or air-REG mix is compressed, the temperature adjusted and presented by system shown in FIG. 2 and FIG. 4, to intake manifold 13, the charge then received on the intake stroke of piston 22, going through intake valve 16i into cylinder 7x, the piston traveling to BDC of cylinder 7x, intake valve 16i (or V15 of FIG. 5A) closing and reversing travel with outlet valve 16o or V15 opening at piston BDC. With the outlet valve open piston 22 pumps the cool charge.

### Spark-Ignition

Referring again to FIG. 6, the preferred method of this pre-combustion chamber, low effective compression ratio combustion system is hereby described. A charge of highly compressed, cool air or air-REG charge is taken into, in system (a) cylinder 7x on the intake stroke as fuel is fed into precombustion chamber 38′ by way of conduit 41 and 36, with the air charge entering the combustion chamber proper 38 and cylinder 7x by way of inlet valve 16i or valve V15 through port 16pi, filling the cylinder by intake valve 16i or V15, FIG. 4A closing and outlet valve 16o or V15 opening at piston BDC as piston 22 reverses and begins the charge adjustment-engine cooling/compression and precombustion chamber charging stroke, piston 22 proceeds to, with great speed and force to pump the entire cool air charge in reverse which roiling charge impinges on underside of the closed exhaust valve 17e (shown in FIG. 4, FIG. 4A and FIG. 4B), closed intake valve 16i, open outlet valve 16o or V15 blowing against the walls of cylinder 7x and inner structures of the cylinder head and with a large portion of the charge after cooling these said components is recessed and expelled, exiting through outlet valve 16o or outlet port of valve V15 (before its closure to trap the volume of charge necessary to, after further compression, fueling and igniting, to power the engine), and outlet port 16po, with the recessed cooling air from conduit 15ao now containing adsorbed heat passing through air or water-cooled intercooler 14C, where the heat absorbed from the engine components is dispelled alternatively after each firing-power and exhaust stroke and with the now re-cooled recessed portion of the charge air or air-REG mixture returning by way of conduit 15a to intake manifold 13 which originally received the charge air which was processed by and is used by engine of FIG. 2, it now being in conjunction with the combustion system of FIG. 6.

Now during the charge-adjusting engine cooling/compression (2^{nd}) stroke, valve 16i or V15 intake port is closed at piston 22 turnaround and outlet valve 16o or outlet port of V15 which has remained open during a portion of this second stroke now in combustion system (a) closes at a predetermined point in the stroke, which portion now trapped for further compression lies alternatively between 80% to 0% of the displaceable volume of cylinder 7x. For combustion system (b) outlet valve 16o or V15 closes during the second stroke to trap non-selectively any volume of charge contained at any specified point between 80 and zero % of displaceable volume of cylinder 7x, this in system (a) and (b) to be further compressed and ignited alternatively at 20-5° BTDC, the gases expanding against piston 22 for the power stroke.

In combustion systems (a) and (b) after the recessed “cooling” charge has been expelled and at the point that valve 16o or V15 closes, further compression takes place on the charge trapped in cylinder 7x, compressing it into combustion chamber 38 and through ports 4 into pre-combustion chamber 38′. Any auxiliary fuel required in the combustion chamber proper 38 is injected by fuel injector 24, fed by conduit 23 into roiling turbulence in-cylinder, the fuel being in quantity to produce a fuel-lean mixture of fuel and oxygen as concurrently further compression takes place on the main charge preferably before piston 22 reaches between 20-5° BTDC.

The effective compression ratio of the engine is found by adding the volume of charge remaining in cylinder 7x at valve closing to the total volume of the two combustion chambers divided by the total volume of the two combustion chambers.

With combustion system (b) operation, although the effective compression ratio is not variable, in combustion system (b) power and/or speed of the engine are varied by varying the charge density and/or by varying the fuel input.

Now in combustion system (a) or (b), the two-stage combustion occurs alternatively, in one of these described ways:
(1) The position of the spark plug as shown in FIG. 6 enhances the effectiveness of the system. In this position in the precombustion chamber 38′ the spark initiation and the flame front in the precombustion chamber 38′ is near the outlet ports 4 and near to the main combustion chamber 38, ensuring that the required extremely fuel-rich air mixture is more completely burned before entering the main combustion chamber 38 than the fuel mixture that would be burned if the source of the ignition was at the top of the precombustion chamber. Also mixing of fuel in the precombustion chamber 38′ with the combustion air from the main combustion chamber during the compression of the air or air-REG mix charge in-cylinder, compresses the air or air-REG charge through outlet port(s) 4, into precombustion chamber 38′ which provides an optimum air/fuel mixture for initiation and support of combustion during the power stroke.

### First Combustion Stage

(1) The intake (1^{st}) stroke occurs receiving highly compressed, cooled air or air-REG mix into combustion chamber 38 as fuel is fed past check valve 1 by conduit 36 into precombustion chamber 38′. At piston BDC intake valve 16i or V15, FIG. 4A, closes and valve 16o or outlet port of valve V15 opens. Piston 22 rises in the engine cooling process, the first portion of charge is expelled in order to cool engine, with outlet valve 16o or V15 then closing, trapping the proper volume of charge needed and beginning the final compression process and during the final travel of piston 22 in the compression stroke, in combustion systems (a) and (b), alternatively, with piston 22 at between 20 and 5° BTDC, the charge in precombustion chamber 38′ is ignited by spark plug 25. The pre-combustion occurs in the pre-combustion chamber 38′ with an extremely fuel-rich, (fuel greatly in excess of the amount of oxygen molecules present) charge, with piston 22 now near TDC. During this stage of combustion the deficiency of oxygen, along with an extremely turbulent and cooler charge with low peak temperatures and pressures, greatly reduces the formation of NOx. The extreme roiling turbulence and hot pre-combustion chamber walls along with the low point of flame initiation and propagation provide much more complete combustion. The ignited fuel in the precombustion chamber now expands rapidly as a plasma-like blast into, in (2) an air or an air-REG charge, or alternatively in (2c) into a lean fuel-air or fuel-air-REG mixture in the combustion chamber 38 proper creating a roiling turbulence, promoting flame propagation in a homogeneous mixture eliminating cycle-to-cycle variations of combustion components, increasing flame speed and with uniform combustion.

### Second Stage of Combustion

(2) Alternatively, the second stage of combustion initiated and sustained by the fiery blast from precombustion chamber 38′ takes place at relatively lower temperatures and now relatively lower pressures in the combustion chamber 38 proper above piston 22 in cylinder 7x as the burning gases with alternatively any accompanying excess fuel, expands into the cylinder proper. Alternatively, the accompanying fuel from pre-combustion chamber 38′ is adequate to provide a very lean combustion, spreading throughout cylinder 7x, all ignited by the flaming blast from pre-combustion chamber 38′. The relatively lower temperature in cylinder 7x and the very adequate mixture of the burning gases prevent any further formation of nitrous or nitric oxides. Excess air, with strong roil of turbulent action, and the greatly extended expansion process assures a more complete combustion of carbon monoxide, hydrocarbons and carbon.
(2c) Alternatively, at the time or after outlet valve 16o or V15 closes during the compression stroke, in stage one of this two-stage combustion system, fuel is injected by fuel injector 24, FIG. 6, directly into combustion chamber 38, forming a fuel-lean mixture, mixing with the roiling, highly turbulent charge during the compression phase until piston at near TDC is driven backward by the flaming gases now developing in combustion chamber 38 proper. In either (2) or (2c), the second stage of combustion is alternatively a very lean fuel mixture, and the leaner mixture is ignited by the fiery blast in either case from the pre-combustion chamber 38′ providing all of the advantages expressed for second stage of combustion (1).
Alternatively, in the first stage of combustion and also in both (2) and (2c) of the second stage of combustion, more complete combustion is provided by combining the fifth embodiment of this invention, that of doubling or more, the burning time of the charge which improved burning time is alternatively, variable and is varied, as shown and described for FIG. 5 in concert with the advantages of that described for engine of FIG. 2 and FIG. 4. The torque of the engine can also be multiplied to double or more and is also variable and is varied, as taught in the same FIG. 5 illustration and description, thus combining the embodiments of FIG. 2, FIG. 4, FIG. 4A, FIG. 4B, FIG. 5, FIG. 6 and FIG. 7 into one super-performance engine.
The results of the engine of FIG. 2 using the low effective compression ratios and longer burning time with the pre-combustion chamber 38′ system as described for FIG. 1, FIG. 2, FIG. 4, FIG. 4A, FIG. 4B, FIG. 5, FIG. 6 and FIG. 7 are: higher thermal efficiencies due to the greater expansion process and a much denser charge, along with a cooler working cycle, which provides higher power, torque, fuel economy and greater engine life with extremely low polluting emissions.
(2d) The culmination of the compounded combustion system with improved mechanical features is a superior performance engine. The expansion of the charge drives piston 22 to BDC where the exhaust valve (illustrated in FIG. 4 and FIG. 4A) opens and the exhaust (4^{th}) piston stroke occurs displacing the exhausted gases into exhaust conduit 18a of FIG. 2, the exhaust gases passing through conduit 18a, an optional diesel particulate filter (DPF) and is then directed to at least one gas turbine 7 driving a turbocharger 1 and which exhaust gases can be directed to as many as four turbochargers, all in-line, to boost charge pressures, allowing effective compression ratios to 4:1, 2:1 and lower.

This completes one working cycle of the engine of FIG. 2 utilizing a pre-combustion chamber combustion system of FIG. 6 and alternatively the variably extended burning time and increased torque, which embodiments are also controllably variable, both described in FIG. 5 for the engine of FIG. 1, FIG. 2, FIG. 4, FIG. 4A, FIG. 4B, FIG. 6, FIG. 7 or for any current 4-stroke cycle engine.

### Two Stage Diesel Ignition for Liquid or Gaseous Fuels

Referring now to FIG. 7, there is shown an engine precombustion chamber system operating in conjunction with the engine of FIG. 2 with other components shown in FIG. 4, FIG. 4A, FIG. 4B, shown here with the outlet valve 16o and intake valve 16i closed and during operation the intake stroke of piston 22 allowing the entrance of highly compressed cool air, or air-REG mix to rush into and through inlet port 16pi and intake valve 16i now open, filling cylinder 7x.

At piston 22 BDC intake valve 16i¹ closes and outlet valve 16o opens, piston 22 reverses course and begins the charge-adjustment engine-cooling/compression stroke. The piston 22 then with power and speed, drives the very dense, cool, roiling charge against the cylinder 7x walls, the exhaust valve and against the interior surfaces of the head, against intake valve 16i and a very significant portion, alternatively from 20-50% of the displaceable volume of cylinder 7x being recessed, going out port 16po and outlet valve 16o through conduit 15ao and alternatively through intercooler 14C, in which intercooler the heat absorbed from engine components is dissipated by air or water cooling, the recessed charge, now again cooled going through the upper section of conduit 15a and into intake manifold 13, which manifold receives the now re-cooled charge air which originated coming through conduit 114 which charge is originally produced and delivered by the engine of FIG. 2 and other embodiment of FIG. 2 shown in FIG. 4 or FIG. 4B, which engine is now operating with the combustion system of FIG. 7. ¹ In an alternate inlet/outlet system illustrated and described for FIG. 4A, a single two way valve V15 allows entrance of the charge from one conduit 16ai, then during the second stroke, valve V15 directs the recessed charge to conduit 15ao, then closing as the outlet valve to trap the proper volume of combustion charge.

In the combustion system as described for FIG. 7, diesel fuels are alternatively used for charge ignition in the pre-ignition chamber 38′ while a variety of other gaseous or liquid fuels are useful for the main fuel. Some alternate fuels for ignition by diesel ignition are: natural gas, hydrogen, propane, gasoline, gasohol, alcohols and many other liquid or gaseous fuels and for liquefied gases such as hydrogen.

During this charge-adjustment, engine-cooling/compression (3^{rd}) stroke valve 16i, being closed, outlet valve 16o closes at a predetermined point of this second stroke to interrupt the flow of recessed charge and to capture a volume of charge (a) which is then further compressed, a portion going through ports 4, into precombustion chamber 38′ and the rest into combustion chamber 38, thus establishing the effective compression ratio in cylinder 7x and precombustion chamber 38′.

Alternatively combustion system (b), is performed the same as in combustion system (a) with the exception that the volume trapped at closure of outlet valve 16o is constant, therefore, the effective compression ratio is non-selective. The combustion is the same as in combustion system (a) with intake valve 16i or V15, FIG. 4A closing at piston BDC and outlet valve 16o or V15 opening at piston BDC, then in the second stroke of piston 22 excess charge is recessed, outlet valve 16o closes trapping any charge remaining outside of the combustion chamber 38, then further compressing the remaining charge into compression chamber 38 and with a portion of the charge then being compressed through outlet ports 4 of precombustion chamber 38′. Then in combustion systems (a) and (b), alternatively with piston at between approximately 20-5° BTDC, the air charge in precombustion chamber 38′ is ignited, by fuel injector 24P spraying diesel fuel into the precomubstion chamber 38′ and directly onto glow plug 37 alternatively the injections beginning late in the compression stroke, the main injection being onto the glow plug with other fuel injections early in the combustion process. The ignited fuel-air or fuel-air-REG charge now expands rapidly into the combustion chamber 38 which alternatively may receive additional fuel injected by injector 24 after closure of outlet valve 16o being closed in the compression stroke of piston 22 with ignition of secondary charge happening in conjunction with the pilot ignition. The fuel-air or fuel-air-REG mixture in combustion chamber 38′ is alternatively mad of very fuel-rich mixture while any fuel injected into combustion chamber proper alternatively forms a lean fuel mixture in which the combustion is relatively cool compared to the combustion in precombustion chamber 38′. Due to the fuel-rich air mixture in the first stage of combustion and the lower temperature and excess oxygen in the second stage of combustion, along with the extended expansion process and great roil turbulence, assures production of a more complete combustion of carbon monoxide, hydrocarbons and carbon with extremely low noxious odors.

In combustion system (a), the effective compression ratio is variable and is varied with the preferred effective compression ratio being between 9:1 and 8:1, while in situation (b) the effective compression ratio is not varied and is alternatively approximately 8:1, and the charge is alternatively ignited at 20-5° BTDC of piston. In combustion system (a) and (b), with liquid or gaseous fuel being compression ignited, the ignition is enhanced by use of a glow plug 37. For starting the engine, the intake air is heated electrically.

In combustion systems (a) and (b) at combustion, the piston 22 is driven to near BDC position, exhaust valve 17e, shown in FIG. 4, opens and piston 22 rises in the exhaust stroke, the exhaust valve 17e closing near piston 22 TDC, the exhausted gases with those from other cylinders of the engine, collectively going through conduits 18a of FIG. 2, which engine is in concert with the precombustion chamber 38′ system, their exhaust gases driving from one to four turbo-chargers, thus increasing the density of the incoming charge air or air-REG.

This completes one working cycle for the engine of FIG. 2 and FIG. 4, in conjunction with the two-stage diesel combustion system with the precombustion chamber 38′ system and alternate fuel injectors 24 and 24P, and alternatively in conjunction with the mechanically increased combustion time and the increased torque, both of which are variable in the degree of increase in performance as illustrated in and described by FIG. 5.

### Regarding Pollution Control

Referring now to FIG. 1 and FIG. 2, there is shown a method of further reducing polluting emissions in any of the engine embodiments of this invention, which includes re-burning a portion of the exhausted gases when and if required. In the 4-stroke engines of FIG. 1, FIG. 2, FIG. 6 and in the rotary engines of FIG. 1B and FIG. 2B, the exhaust outlet conduit(s) 18 have a first shunt, conduit 202 (refer to FIG. 1 and FIG. 2) leading from a port 206 in the side of exhaust conduit 18 downstream of turbine 15 to a port 204 and valve 201 which is alternatively a venturi in the side of intake conduit 8. A proportioning valve 201 is situated at the intake port 204 and is arranged to selectively restrict the flow of fresh air into conduit 8, while at the same time opening the port 204 to the exhaust conduit to selectively allow entry of exhaust gases to the intake conduit 8. This valve is variable and mechanically, electrically or vacuum or solenoid operated and preferably controlled by an engine control module (ECM-27). This allows the re-burning of a portion of the exhausted gases, the amount of percentages thereof being adjusted by the engine control module in response to various sensors, such as an oxygen sensor, placed in strategic positions in the engine. Exhausted gases passing through conduit 202b are alternatively un-cooled or are alternatively cooled by either optional cooling fins 202a or by passing through an optional intercooler (not shown) before reaching the air intake conduit 8. Alternatively, a second shunt conduit 202b (refer to FIG. 1 and FIG. 2) leading from a port 206b in the side of exhaust conduit 18 upstream of turbine 15, as also are both 206 and 206b, to a port 204b in the side of intake conduit 8. A proportioning valve 201b, which is alternatively a venturi, is situated at the intake port 204b and is arranged to selectively restrict the flow of fresh air into conduit 8, while at the same time opening the port 204b to the exhaust conduit to selectively allow entry of exhaust gases to the intake conduit 8. This valve is variable and mechanically, electrically or vacuum or solenoid operated and preferably controlled by an engine control module (ECM-27). This allows the re-burning of a portion of the exhausted gases, the amount and percentages thereof being adjusted by the engine control module in response to various sensors, such as an oxygen sensor, placed in strategic positions in the engine. Exhausted gases passing through conduit 202b are also alternatively un-cooled or are alternatively cooled by either optional cooling fins 202b or by passing through an optional intercooler (not shown) before reaching the air intake conduit 8.

In using either or in using both alternative exhaust gas recirculation arrangements, each proportioning valve 201, 201b would allow either a portion or none of the exhausted gases to enter its respective port, meanwhile restricting entrance of fresh air if necessary. The exhausted gases can optionally be cooled by optionally arranging cooling fins on conduit 202′ and/or 202b or by passing the exhaust through an optional intercoolers (not shown) before the gases are introduced into the air intake(s) of the engine.

It will be seen by the foregoing description of a plurality of embodiments of the present invention, that the advantages sought from the present invention are common to all embodiments.

While there have been herein described approved embodiments of this invention, it will be understood that many and various changes and modifications in form, arrangement of parts and details of construction thereof may be made without departing from the spirit of the invention and that all such changes and modifications as fall within the scope of the appended claims are contemplated as a part of this invention.

While the embodiments of the present invention, which have been disclosed herein are the preferred forms, other embodiments of the present invention will suggest themselves to persons skilled in the art in view of this disclosure. Therefore, it will be understood that variations and modifications can be effected within the spirit and scope of the invention and that the scope of the present invention should only be limited by the claims below. Furthermore, the equivalents of all means-or-step-plus-function elements in the claims below are intended to include any structure, material, or acts for performing the function as specifically claimed and as would be understood by persons skilled in the art of this disclosure, without suggesting that any of the structure, material, or acts are more obvious by virtue of their association with other elements.

1. Method for operating a reciprocating, internal combustion engine, comprising (i) producing an air or air-recirculated-exhaust-gas (REG) charge, (ii) adjusting the temperature, density and pressure of the charge such that the charge has a weight and density selected from a range of weight and density levels ranging from atmospheric weight and density to a heavier-than-atmospheric weight and density, (iii) transferring the charge to chamber of the engine with turbulence, (iv) at the beginning of the compression stroke or process, adjusting the combustion charge volume by recessing a selective portion of the charge, which charge has absorbed heat from the engine inner components, (v) expelling the portion of the charge from the chamber, going through a valve and an intercooler and returning by conduit to an intake manifold, (vi) adjusting the charge volume by closing the valves and trapping a volume of charge at any level of between 80% and zero percent of the displaceable volume of the cylinder or compression chamber, plus the volume of the combustion chamber, (vii) further compressing charge trapped by valve closure, (viii) causing a predetermined quantity of charge-air and fuel, or charge-air-fuel-REG mix, to produce a combustible mixture, (ix) causing the mixture to be ignited within the combustion chamber, (x) allowing the combusting gas to expand against and to the length of travel by a piston in the chamber with the expansion ratio being substantially greater than the effective compression ratio of the engine, and (xi) opening an exhaust valve or port at or near the end of the expansion process.

2. The method of claim 1, further comprising, causing the charge to be ignited with the piston at between 20 and 5 degrees of crank angle before top dead center (BTDC) of piston travel, or “seating” of the combustion chamber

3. The method of claim 2, further comprising, allowing the exhausted gases, assisted by the piston to travel by a conduit to and through an optional filter, with an optional valve alternatively adjusting the volume of exhaust gases driving a turbine of a turbocharger.
